(19) United States
(12) Patent Application Publication
(10) Pub. No.: US 2026/0237182 A1
(43) Pub. Date: Aug. 13, 2026

(54) USING ARTIFICIAL INTELLIGENCE FOR GENERATING DISPLAY PARAMETERS IN CONTENT STREAMING SYSTEMS AND APPLICATIONS

(71) Applicant: NVIDIA Corporation, Santa Clara, CA (US)

(72) Inventors: Jithin Thomas, Pune, (IN); Pankaj Ratnakar Kadtan, Pune, (IN); Shashikant Jadhav, Pune, (IN)

(21) Appl. No.: 19/049,487

(22) Filed: Feb. 10, 2025

(51) Int. Cl. G06V 10/75; G06V 10/54; G06V 10/56; G06V 10/60; G10L 15/26

(52) U.S. Cl. CPC G06V 10/751; G10L 15/26; G06V 10/54; G06V 10/56; G06V 10/60

(57) ABSTRACT

In various examples, using artificial intelligence to alter content for streaming systems and applications is described herein. Systems and methods are disclosed that allow for users to update visual characteristics of applications—such as the contrast, saturation, brightness, luminance, color, texture, and/or the like—in real-time using one or more machine learning models. For instance, a user may provide input associated with updating a visual characteristic, such as in the form of speech and/or text. The machine learning model(s) may then process the input along with an image of the application to generate and provide sample images associated with the updated visual characteristic. Additionally, based on a selection of sample image, the machine learning model(s) may use at least the selected image to generate visual data (e.g., shader code) representing parameters for updating the visual characteristic for additional images rendered for the application.

### BACKGROUND

While the appearances of gaming applications are usually set by game developers, some players may still want to update visual characteristics to help improve the appearances of the gaming applications and/or the performances of the players. As such, some conventional systems may allow for players to set parameters for various visual characteristics associated with gaming applications. For instance, a player may set a display setting or parameter (e.g., a contrast level, a brightness level, a saturation level, etc.) that a conventional system may then use when processing images of a gaming application. However, these gaming applications are typically limited to a pre-determined list of parameter values that players may select from to update the visual characteristics. This limits the ability of the conventional systems to provide players with the ability to precisely customize the appearances of the gaming applications to their specific preferences.

### SUMMARY

Embodiments of the present disclosure relate to using artificial intelligence to alter content for streaming systems and applications. Systems and methods are disclosed that allow for users to update visual characteristics of applications—such as the contrast, saturation, brightness, luminance, color, texture, and/or the like—in real-time using one or more machine learning models. For instance, a user may provide input associated with updating a visual characteristic, such as in the form of speech and/or text. The machine learning model(s) may then process the input along with an image of the application to generate and provide sample images associated with the updated visual characteristic. Additionally, based on a selection of sample image, the machine learning model(s) may use at least the selected image to generate visual data (e.g., shader code) representing parameters for updating the visual characteristic for additional images rendered for the application. In some examples, the machine learning model(s) may be trained to perform one or more of the processes described herein, such as to generate the shader code for updating the visual characteristics.

In contrast to conventional systems, such as those described above, the systems of the present disclosure, in some embodiments, may use the machine learning model(s) to update the visual characteristics of images corresponding to an application in real-time. For instance, and as described above, the conventional systems may provide a pre-compiled list of parameters that users may use to update one or more of the visual characteristics. However, by just providing the pre-compiled list, the conventional systems may be limited in how the appearances of the applications may be updated and/or may not provide the users with the desired effects. In contrast, by using the machine learning model(s) to update the visual characteristics using one or more of the processes described herein, the systems of the present disclosure are able to update additional parameters for visual characteristics. Additionally, and as described in more detail herein, by using the machine learning model(s) that is trained to generate the visual data (e.g., shader code) for updating the visual characteristics, the systems of the present disclosure may more accurately update the visual characteristics based on parameters selected by users.

### BRIEF DESCRIPTION OF THE DRAWINGS

The present systems and methods for using artificial intelligence to alter content for streaming systems and applications are described in detail below with reference to the attached drawing figures, wherein:

FIG. 1 illustrates an example of a process for using artificial intelligence to alter content associated with systems and/or applications, in accordance with some embodiments of the present disclosure;

FIGS. 2A-2B illustrate an example of selecting a sample image for further processing, in accordance with some embodiments of the present disclosure;

FIG. 3 illustrates an example of processing images in order to determine parameters for updating visual characteristics, in accordance with some embodiments of the present disclosure;

FIG. 4 illustrates an example of generating visual data that is used to update visual characteristics associated with images, in accordance with some embodiments of the present disclosure;

FIG. 5 illustrates an example of updating visual characteristics associated with an image, in accordance with some embodiments of the present disclosure;

For more details, FIGS. 6A-6B illustrate example of determining feedback that is then used to update data representing parameters for updating visual characteristics, in accordance with some embodiments of the present disclosure;

FIG. 7 illustrates an example of a data flow diagram for training one or more machine learning models to generate data for updating visual characteristics of images, in accordance with some embodiments of the present disclosure;

FIG. 8 illustrates a flow diagram showing a method for using artificial intelligence to generate shader code for altering content associated with an application, in accordance with some embodiments of the present disclosure;

FIG. 9 illustrates a flow diagram showing a method for using artificial intelligence to alter content associated with an application, in accordance with some embodiments of the present disclosure;

FIG. 10 illustrates a flow diagram showing a method for using feedback to update visual data associated with parameters for visual characteristics, in accordance with some embodiments of the present disclosure;

FIG. 11 is a block diagram of an example content streaming system suitable for use in implementing some embodiments of the present disclosure;

FIG. 12 is a block diagram of an example computing device suitable for use in implementing at least some embodiments of the present disclosure;

FIG. 13 is a block diagram of an example data center suitable for use in implementing at least some embodiments of the present disclosure;

FIG. 14A is a block diagram of an example generative language model system suitable for use in implementing at least some embodiments of the present disclosure;

FIG. 14B is a block diagram of an example generative language model that includes a transformer encoder-decoder suitable for use in implementing at least some embodiments of the present disclosure; and

FIG. 14C is a block diagram of an example generative language model that includes a decoder-only transformer architecture suitable for use in implementing at least some embodiments of the present disclosure.

### DETAILED DESCRIPTION

Systems and methods are disclosed related to using artificial intelligence to alter content for streaming systems and applications. For instance, a system(s) may host a session of an application with a client device. As described herein, an application may include, but is not limited to, a gaming application, an interactive application (which may include one or more of these other types of applications), a visual application (which may include one or more of these other types of applications), a multimedia application (e.g., a video streaming application, a music streaming application, a voice streaming application, a multimedia streaming application that includes both audio and video, etc.), a communications application (e.g., a video conferencing application, etc.), an educational application, a collaborative content creation application, an entertainment application (e.g., a show, a movie, etc.), or any other type of application.

In some examples, the system(s) may be included within and/or be part of the client device. In other examples, the system(s) may be remote from the client device and communicate with the client device using one or more networks. For instance, during the session, the client device may generate input data representing one or more inputs received from the user via one or more input devices. The system(s) may then receive the input data from the client device, use the input data to update a state of the application, and then send content data (e.g., image data, audio data, etc.) representing the current state of the application back to the client device. Using the content data, the client device may then provide the content to the user, such as by displaying one or more images depicting the current state and/or outputting sound associated with the current state.

The system(s) may then receive input data representing a request to update one or more visual characteristics associated with the content of the application. In some examples, the input data may include audio data representing speech from a user, where the speech indicates the request to update the visual characteristic(s). However, in other examples, the input data may include any other type of data, such as text data, selection data representing one or more options, and/or the like. Additionally, in some examples, the request may indicate a level and/or degree associated with updating the visual characteristic(s). For a first example, if the visual characteristic is associated with a brightness, then the request may indicate to increase the brightness and/or increase the brightness by a given level. For a second example, if the visual characteristic is associated with contrast, then the request may indicate to increase the contrast and/or increase the contrast ratio by a given amount.

The system(s) may then use one or more image generators to generate and/or provide one or more sample images that are associated with the visual characteristic(s) as updated. As described herein, an image generator may include and/or use one or more machine learning models (e.g., one or more language models, one or more generative AI models, etc.), one or more neural networks, one or more classifiers, one or more modules, one or more algorithms, software, hardware, one or more processors, and/or any other type of processing component. To generate the sample images, the image generator(s) may process the input data along with image data representing a reference image rendered for the application to update the visual characteristic(s) of the reference image. For example, if the request is to update the brightness, then the image generator(s) may generate sample images that include different levels of increased brightness as compared to the reference image.

The system(s) may then provide the sample image(s) to the user for selection. For example, the system(s) may cause the client device to display a user interface that includes the sample image(s), where the user is then able to use the user interface to select a sample image that best represents the visual characteristic(s) as updated. Additionally, the system(s) may use the reference image along with the selected image to determine one or more parameters that are associated with the visual characteristic(s) as updated. For example, the system(s) may determine one or more differences between the reference image and the selected image—such as differences in pixel colors (e.g., pixel values), attributes, and/or the like—and determine the parameter(s) based at least on the difference(s). As described herein, in some examples, the parameter(s) may include at least red-green-blue (RGB) pixel value information, luminance information (e.g., a range of relative luminance levels, etc.), contrast detail information (e.g., a contrast ratio, etc.), brightness information (e.g., a brightness level, etc.), saturation information (e.g., a saturation level, etc.), color information, texture information, and/or any other type of parameter associated with a visual characteristic. The system(s) may then generate parameter data representing the parameter(s) associated with the visual characteristic(s).

Additionally, the system(s) may use one or more data generators to process the parameter data representing the parameter(s) and, based at least on the processing, generate visual data that is used for updating rendered images corresponding to the application. As described herein, an image generator may include and/or use one or more machine learning models (e.g., one or more language models, one or more generative AI models, etc.), one or more neural networks, one or more classifiers, one or more modules, one or more algorithms, software, hardware, one or more processors, and/or any other type of processing component. Additionally, in some examples, the visual data may represent one or more shader files, shader code, one or more instructions, one or more declarations, one or more variables, one or more functions, and/or any other type of data that is configured to perform one or more of the processes described herein. For instance, in some examples, the visual data may represent shader code that is configured to cause the desired visual characteristic(s) update based on the parameter(s) determined using the processing described herein.

For instance, the system(s) may use the visual data to process rendered images in order to generate updated images that include the visual characteristic(s) as updated. For example, the visual data may cause the system(s) (e.g., a graphics processing unit, etc.) to update the pixel values, the luminance, the contrast, the brightness, the saturation, the color, the texture, and/or any other visual characteristic of the rendered images to generate the updated images. As such, since the visual data is associated with the parameter(s) determined based on the selected image, the updated images generated by the system(s) may include similar updates to the visual characteristic(s) as the selected image. In some examples, the system(s) may then cause the client device to present the updated images, such as by sending image data representing the updated images to the client device and/or providing the image data to a display of the client device.

In some examples, the system(s) may use feedback to update the visual data for the requested visual characteristic(s). For instance, in some examples, the system(s) may use the visual data to process the reference image used to generate the sample images in order to generate an updated image. The system(s) may then determine one or more differences (e.g., one or more errors) between the updated image and the selected image and determine one or more updated parameters based at least on the difference(s). Additionally, the data generator(s) may use the parameter(s) to update the visual data (e.g., update the shader code). Additionally, or alternatively, in some examples, the system(s) may use the visual data to process a new rendered image in order to generate an updated image. The system(s) may then determine one or more differences (e.g., one or more errors) between the updated image and the new rendered image and use the difference(s) to determine one or more updated parameters. The data generator(s) may then use the updated parameter(s) to update the visual data (e.g., update the shader code). While these are just two example techniques for how the system(s) may process images to update the visual data, in other examples, the system(s) may use additional and/or alternative techniques to update the visual data based on processing image.

In some examples, the system(s) may use feedback from the user to update the visual data. For instance, the system(s) may receive additional input data representing an additional request to update the visual characteristic(s). In some examples, the system(s) may then use the additional input data to perform one or more of the processes described herein to determine new visual data for updating the visual characteristic(s). Additionally, or alternatively, in some examples, the system(s) may use the additional input data to directly update the visual data without again generating and/or providing sample images to the user for selection. For example, if the additional request is to increase the contrast of the images, then the data generator(s) may process the input data and, based at least on the processing, update the visual data. For instance, the data generator(s) may update the visual data such that the updated visual data increases the contrast of images.

As described herein, one or more of the models may be trained to perform one or more of the processes described herein. For instance, if the data generator(s) uses the machine learning model(s) to generate the visual data, then the system(s) may train the machine learning model(s) to generate visual data based on various types of inputs. For example, the system(s) may train the machine learning model(s) using training data, such as rendered images, desired images, and shader files. As such, during training, the machine learning model(s) may process data associated with the rendered images and the shader files and generate visual data based at least on the processing. The system(s) may then use the visual data to update the rendered images to generate updated images and compare the updated images to the desired images. Additionally, the system(s) may determine losses based on the comparing and update one or more parameters and/or weights associated with the machine learning model(s) using the losses. By performing such processes, the machine learning model(s) may be trained to generate and/or update visual data, such as shader code, based on requested visual characteristics.

As described herein, in some examples, the system(s) may remote from and communicate with the client device. For example, the system(s) may correspond to a cloud-based system that receives inputs from the client device, such as at least the input data representing the request to update the visual characteristic(s). The system(s) may then perform one or more of the processes described herein to update the visual characteristic(s) of the application and send image data representing the updated images to the client device for display. However, in other examples, the system(s) may be included as part of the client device. For example, the system(s) may generate and/or receive (e.g., from one or more other systems) rendered images associated with the application. The system(s) may then receive the input data, perform one or more of the processes described herein to update the visual characteristic(s) of the rendered images based on the input data, and cause the client device to display the updated images.

Additionally, while the examples herein are described with respect to gaming applications, in other examples, similar processes may be performed with regard to other types of applications. For instance, the processes described herein may be performed to update visual characteristics of images and/or videos with regard to any type of application that provides content to users.

In some examples, the machine learning model(s) (e.g., deep neural networks, language models, LLMs, VLMs, multi-modal language models, perception models, tracking models, fusion models, transformer models, diffusion models, encoder-only models, decoder-only models, encoder-decoder models, neural rendering field (NERF) models, etc.) described herein may be packaged as a microservice—such an inference microservice (e.g., NVIDIA NIMs) which may include a container (e.g., an operating system (OS)-level virtualization package) that may include an application programming interface (API) layer, a server layer, a runtime layer, and/or a model “engine.” For example, the inference microservice may include the container itself and the model(s) (e.g., weights and biases). In some instances, such as where the machine learning model(s) is small enough (e.g., has a small enough number of parameters), the model(s) may be included within the container itself. In other examples—such as where the model(s) is large—the model(s) may be hosted/stored in the cloud (e.g., in a data center) and/or may be hosted on-premises and/or at the edge (e.g., on a local server or computing device, but outside of the container). In such embodiments, the model(s) may be accessible via one or more APIs—such as REST APIs. As such, and in some embodiments, the machine learning model(s) described herein may be deployed as an inference microservice to accelerate deployment of a model(s) on any cloud, data center, or edge computing system, while ensuring the data is secure.

For example, the inference microservice may include one or more APIs, a pre-configured container for simplified deployment, an optimized inference engine (e.g., built using a standardized AI model deployment an execution software, such as NVIDIA's Triton Inference Server, and/or one or more APIs for high performance deep learning inference, which may include an inference runtime and model optimizations that deliver low latency and high throughput for production applications—such as NVIDIA's TensorRT), and/or enterprise management data for telemetry (e.g., including identity, metrics, health checks, and/or monitoring). The machine learning model(s) described herein may be included as part of the microservice along with an accelerated infrastructure with the ability to deploy with a single command and/or orchestrate and auto-scale with a container orchestration system on accelerated infrastructure (e.g., on a single device up to data center scale). As such, the inference microservice may include the machine learning model(s) (e.g., that has been optimized for high performance inference), an inference runtime software to execute the machine learning model(s) and provide outputs/responses to inputs (e.g., user queries, prompts, etc.), and enterprise management software to provide health checks, identity, and/or other monitoring. In some embodiments, the inference microservice may include software to perform in-place replacement and/or updating to the machine learning model(s). When replacing or updating, the software that performs the replacement/updating may maintain user configurations of the inference runtime software and enterprise management software.

The systems and methods described herein may be used by, without limitation, non-autonomous vehicles or machines, semi-autonomous vehicles or machines (e.g., in one or more adaptive driver assistance systems (ADAS)), autonomous vehicles or machines, piloted and un-piloted robots or robotic platforms, warehouse vehicles, off-road vehicles, vehicles coupled to one or more trailers, flying vessels, boats, shuttles, emergency response vehicles, motorcycles, electric or motorized bicycles, aircraft, construction vehicles, underwater craft, drones, and/or other vehicle types. Further, the systems and methods described herein may be used for a variety of purposes, by way of example and without limitation, for machine control, machine locomotion, machine driving, synthetic data generation, model training, perception, augmented reality, virtual reality, mixed reality, robotics, security and surveillance, simulation and digital twinning, autonomous or semi-autonomous machine applications, deep learning, environment simulation, object or actor simulation and/or digital twinning, data center processing, conversational AI, light transport simulation (e.g., ray-tracing, path tracing, etc.), collaborative content creation for 3D assets, cloud computing and/or any other suitable applications.

Disclosed embodiments may be comprised in a variety of different systems such as automotive systems (e.g., a control system for an autonomous or semi-autonomous machine, a perception system for an autonomous or semi-autonomous machine), systems implemented using a robot, aerial systems, medial systems, boating systems, smart area monitoring systems, systems for performing deep learning operations, systems for performing simulation operations, systems for performing digital twin operations, systems implemented using an edge device, systems implementing large language models (LLMs), systems implementing one or more vision language models (VLMs), systems implementing one or more multi-modal language models, systems using or deploying one or more inference microservices, systems that incorporate deploy one or more machine learning models in a service or microservice along with an OS-level virtualization package (e.g., a container), systems incorporating one or more virtual machines (VMs), systems for performing synthetic data generation operations, systems implemented at least partially in a data center, systems for performing conversational AI operations, systems for performing light transport simulation, systems for performing collaborative content creation for 3D assets, systems for performing generative AI operations, systems implemented at least partially using cloud computing resources, and/or other types of systems.

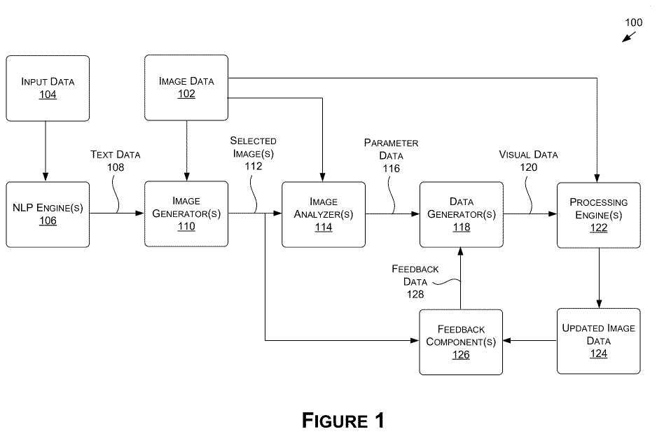

With reference to FIG. 1, FIG. 1 illustrates an example of a process 100 for using artificial intelligence to alter content associated with systems and/or applications, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory.

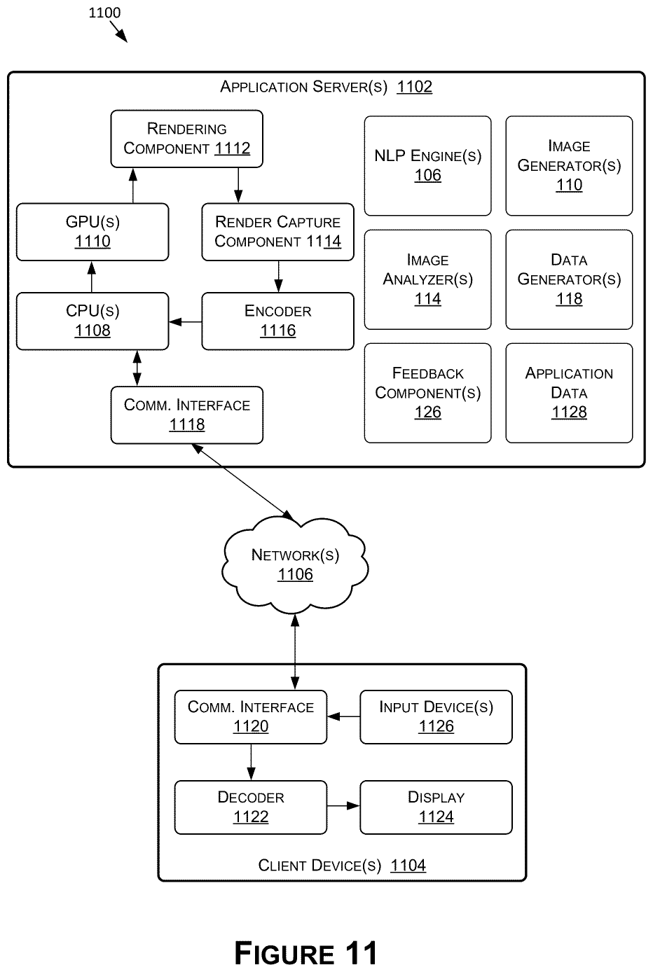

The process 100 may include obtaining, receiving, generating, retrieving, and/or accessing image data 102 representing images associated with an application. As described herein, the application may include, but is not limited to, a gaming application, an interactive application (which may include one or more of these other types of applications), a visual application (which may include one or more of these other types of applications), a multimedia application (e.g., a video streaming application, a music streaming application, a voice streaming application, a multimedia streaming application that includes both audio and video, etc.), a communications application (e.g., a video conferencing application, etc.), an educational application, a collaborative content creation application, an entertainment application (e.g., a show, a movie, etc.), or any other type of application. In some examples, the image data 102 may be generated using one or more processors, such as one or more graphics processing units (which is described in detail with respect to FIG. 11). For instance, the image data 102 may be obtained from an image buffer associated with the graphics processing unit(s) before being displayed using one or more display devices.

The process 100 may also include obtaining, receiving, generating, retrieving, and/or accessing input data 104 representing a request to update one or more visual characteristics associated with the image data 102, such as a luminance, a brightness, a contrast, a saturation, a color, a texture, and/or any other visual characteristic. In some examples, the input data 104 may include audio data representing speech from a user, where the speech indicates the request to update the visual characteristic(s). However, in other examples, the input data 104 may include any other type of data, such as text data representing text, selection data representing one or more options, and/or the like. Additionally, in some examples, the request may indicate a level and/or degree associated with updating the visual characteristic(s). For a first example, if the visual characteristic is associated with a brightness, then the input data may include audio data representing speech, such as “Please increase the brightness of the application” or “I want the brightness of the game to increase by a given level.” For a second examples, if the visual characteristic is associated with contrast, then the input data may again include audio data representing speech, such as “Please increase the contrast of the application” or “I want the contrast ratio of the game to increase.”

The process 100 may include using one or more natural language processing (NLP) engines 106 to process the input data 104 in order to generate text data 108 representing text associated with the request. For instance, in some examples, the NLP engine(s) 106 may include and/or use one or more machine learning models (e.g., one or more automatic speech recognition models, one or more natural language understanding models, one or more text-to-speech models, etc.), one or more neural networks, one or more classifiers, one or more modules, one or more algorithms, software, hardware, one or more processors, and/or any other type of processing component to perform one or more of the processes described herein. For example, if the input data 104 includes audio data representing speech, the NLP engine(s) 106 may be configured to process the audio data in order to generate the text data 108 representing text corresponding to the speech. For instance, the text may represent one or more letters, numbers, words, characters, symbols, and/or other types of text corresponding to the words from the speech.

In some examples, the text data 108 may represent the actual text corresponding to the request. However, in other examples, the text data 108 may represent other types of information. For example, the text data 108 may represent tokens, vectors, embeddings, and/or the like that correspond to the request. This way, the text data 108 may be input into one or more machine learning models, such as one or more language models, for further processing.

The process 100 may then include one or more image generators 110 processing at least a portion of the image data 102 and the text data 108 in order to generate sample images associated with the requested visual characteristic(s) as updated. As described herein, the image generator(s) 110 may include and/or use one or more machine learning models (e.g., one or more language models, one or more generative AI models, etc.), one or more neural networks, one or more classifiers, one or more modules, one or more algorithms, software, hardware, one or more processors, and/or any other type of processing component to perform at least a portion of the processing described herein. The process 100 may then include the image generator(s) 110 selecting at least a selected image 112—such as the sample image that best represents the visual characteristic(s) as updated—for performing further processing.

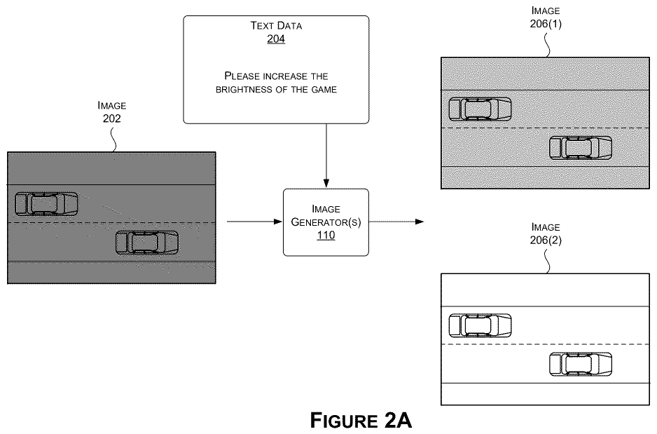

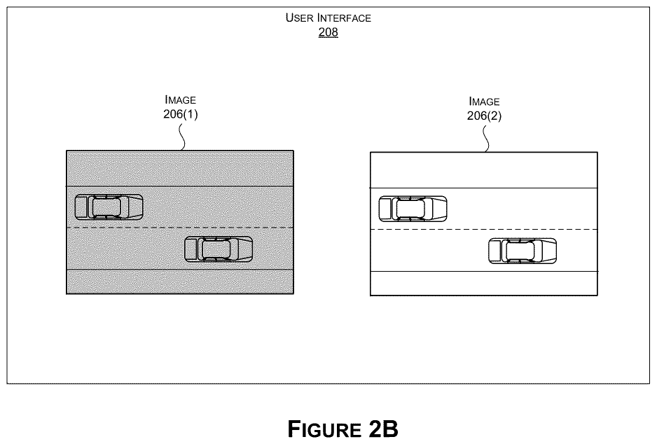

For more details, FIGS. 2A-2B illustrate an example of selecting a sample image for further processing, in accordance with some embodiments of the present disclosure. As shown by the example of FIG. 2A, the image generator(s) 110 may receive image data representing at least a reference image 202 associated with an application, which includes a game in these examples, along with text data 204 (which may include, and/or be similar to, the text data 108) corresponding to a request to update a visual characteristic associated with the application. For instance, the request may be to increase the brightness associated with the game. However, in other examples, the request may be associated with updating any other type of visual characteristic associated with the game, such as the contrast, the saturation, the luminance, the color, the texture, and/or the like. Additionally, in other examples, the request may further include a level and/or degree for updating a visual characteristic. For example, the request may indicate a level and/or degree associated with updating the brightness associated with the game.

As shown, based at least on processing the image data representing the reference image 202 and the text data 204, the image generator(s) 110 may generate image data representing at least a first sample image 206(1) and a second sample image 206(2) that are associated with the visual characteristic as updated. For instance, the first sample image 206(1) may correspond to the reference image 202 with a first increased level of brightness while the second sample image 206(2) may correspond to the reference image 202 with a second, greater increased level of brightness. While the example of FIG. 2A illustrates the image generator(s) 110 as only generating two sample images 206(1)-(2), in other examples, the image generator(s) 110 may generate any number of sample images (e.g., one sample image, four sample images, ten sample images, etc.).

As shown by the example of FIG. 2B, the image generator(s) 110 may cause a user interface 208 to be provided to a user, where the user interface 208 includes at least the sample images 206(1)-(2). The user may then use the user interface 208 to select at least one of the sample images 206(1)-(2). For instance, in the example of FIG. 2B, the user may select the second sample image 206(2). As described herein, the user may use any technique to select the second sample image 206(2), such as through speech, user input, and/or any other technique. For example, the user provide speech that includes “Please update the brightness of the game based on the second sample image.”

Referring back to the example of FIG. 1, the process 100 may include using one or more image analyzers 114 to process the image data 102 representing at least the reference image used to generate the sample images and the selected image 112. As described herein, the image analyzer(s) 114 may include and/or use one or more machine learning models (e.g., one or more language models, one or more generative AI models, etc.), one or more neural networks, one or more classifiers, one or more modules, one or more algorithms, software, hardware, one or more processors, and/or any other type of processing component to perform one or more of the processes described herein. Additionally, the processing performed by the image analyzer(s) 114 may include extracting one or more parameters for updating the visual characteristic(s) of the reference image to include the selected image. In some examples, a parameter may include, but is not limited to, pixel value information, luminance information, contrast detail information, brightness information, saturation information, color information, texture information, and/or any other type of parameter associated with a visual characteristic. The process 100 may then include the image analyzer(s) 114 generating and/or outputting parameter data 116 representing the parameter(s).

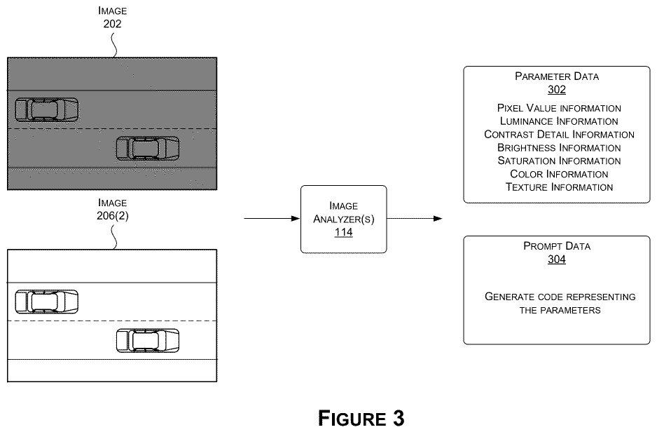

For more details, FIG. 3 illustrates an example of processing images in order to determine parameters for updating visual characteristics, in accordance with some embodiments of the present disclosure. As shown, the image analyzer(s) 114 may process at least image data representing the reference image 202 along with image data representing the second sample image 206(2) selected by the user. In some examples, the processing may include determining differences between the reference image 220 and the second sample image 206(2). For example, the differences may be associated with pixel value differences, luminance differences, contrast differences, brightness differences, saturation differences, color difference, texture differences, and/or any other type of difference between the reference image 202 and the second sample image 206(2). The image analyzer(s) 114 may then use the differences to determine the parameters for updating the visual characteristic(s) of the reference image 202 to include the second sample image 206(2).

The image analyzer(s) 114 may then generate and/or output parameter data 302 representing the parameters. For instance, and as shown, the parameter data 302 may represent one or more of the pixel value differences, the luminance differences, the contrast differences, the brightness differences, the saturation differences, the color differences, the texture differences, and/or any other differences. Additionally, in some examples, the image analyzer(s) 114 may generate and/or output prompt data 304 representing a prompt associated with generating visual data for updating the visual characteristic(s) based on the determined parameter(s). For example, the prompt may be associated with generating shader code that is associated with the determined parameter(s).

Referring back to the example of FIG. 1, in some examples, the parameter data 116 (and/or the prompt data) may represent the actual text describing the parameter(s) (and/or the prompt) However, in other examples, the parameter data 116 (and/or the prompt data) may represent other types of information. For example, the parameter data 116 (and/or the prompt data) may represent tokens, vectors, embeddings, and/or the like that correspond to the parameter(s) (and/or the prompt). This way, the parameter data 116 (and/or the prompt data) may be input into one or more machine learning models, such as one or more language models, for further processing.

The process 100 may include using one or more data generators 118 to process at least the parameter data 116 (and/or prompt data) to generate visual data 120 that may be used to update the visual characteristic(s) of images. As described herein, the data generator(s) 118 may include and/or use one or more machine learning models (e.g., one or more language models, one or more generative AI models, etc.), one or more neural networks, one or more classifiers, one or more modules, one or more algorithms, software, hardware, one or more processors, and/or any other type of processing component. Additionally, and as described in more detail herein, the visual data 120 may represent one or more shader files, shader code, one or more instructions, one or more declarations, one or more variables, one or more functions, and/or any other type of data that is configured to perform one or more of the processes described herein.

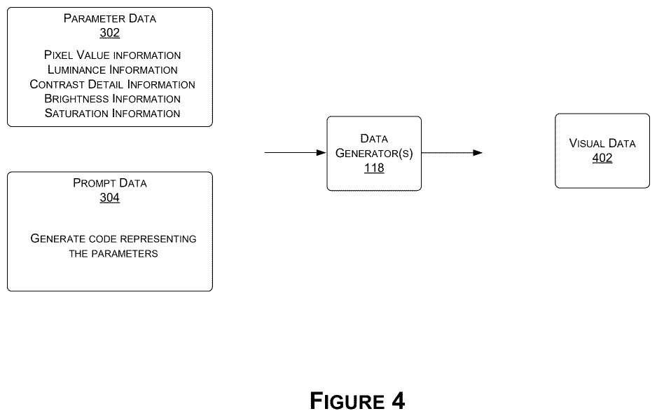

For instance, FIG. 4 illustrates an example of generating visual data 402 (which may represent, and/or be similar to, visual data 120) that is used to update visual characteristics associated with images, in accordance with some embodiments of the present disclosure. As shown, the data generator(s) 118 may process at least the parameter data 302 and the prompt data 304. Based at least on the processing, the data generator(s) 118 may generate the visual data 402 associated with updating images of the application to include the updated visual characteristic(s), such as the increased brightness. For instance, in some examples, the visual data 402 may represent shader code that is associated with the parameter(s) determined to update the visual characteristic(s).

Referring back to the example of FIG. 1, the process 100 may then include one or more processing engines 122 processing at least the image data 102 representing images along with the visual data 120 in order to generate updated image data 124 representing the images with the updated visual characteristic(s). As described herein, the processing engine(s) 122 may include and/or use one or more machine learning models (e.g., one or more language models, one or more generative AI models, etc.), one or more neural networks, one or more classifiers, one or more modules, one or more algorithms, software, hardware, one or more processors, and/or any other type of processing component. For instance, the processing engine(s) 122 may use the parameters represented by the visual data 120 to update the pixel values, the contrast ratio, the pixel intensities, the illuminance level, the saturation, and/or other parameters associated with the images. For example, if the processing engine(s) 122 includes one or more graphics processing units and the visual data 120 represents shader code, then the one or more graphics processing units may use input data representing at least vertex positions and texture coordinates associated with images, perform calculations based on the shader code, and output final pixel colors for rendering the images.

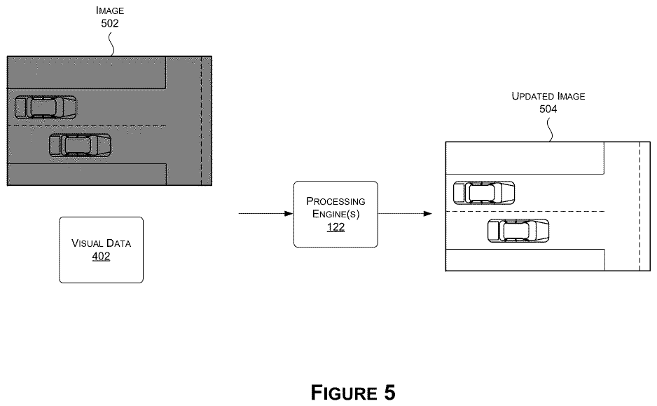

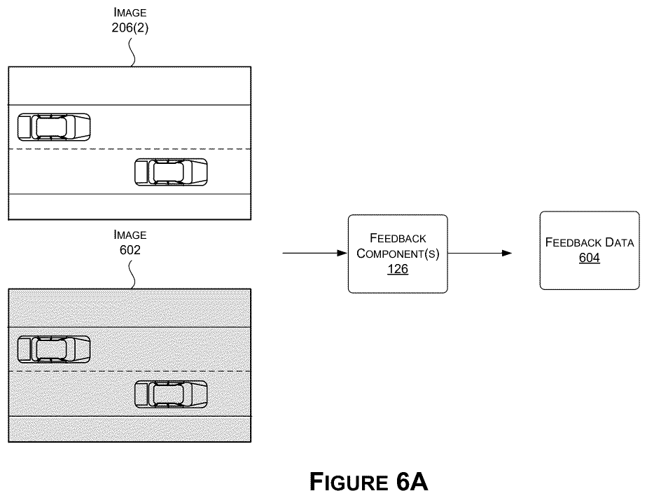

For instance, FIG. 5 illustrates an example updating visual characteristics associated with an image, in accordance with some embodiments of the present disclosure. As shown, the processing engine(s) 122 may process at least image data representing an image 502 associated with the application along with the visual data 402 associated with updating the visual characteristic(s) associated with images. Based at least on processing the data, the processing engine(s) 122 may generate updated image data representing an updated image 504 that includes the updated visual characteristic(s). For instance, in the example of FIG. 5, the processing engine(s) 122 may update the brightness of the image 502 in order to generate the updated image 504 similar to how the brightness of the reference image 202 was updated to generate the second sample image 206(2).

As such, by performing one or more of the processes described with respect to the examples of FIGS. 2A-5, the image generator(s) 110 is able to determine the second sample image 206(2) that best represents the updates to the visual characteristic(s) requested by the user, the image analyzer(s) 114 is able to determine the parameter(s) for updating the visual characteristic(s) using at least the second sample image 206(1), the data generator(s) 118 is able to generate the visual data 402 using at least the parameter(s), and the processing engine(s) 122 is able to generate at least the updated image 504 using the visual data 402. In some examples, the processing engine(s) 122 may then continue to use the visual data 402 to continue updating images associated with the application to include the updated visual characteristic(s).

Referring back to the example of FIG. 1, the process 100 may include using one or more feedback components 126 to determine feedback for updating the visual data 120. As described herein, the feedback may be associated with minimizing the errors in the visual data 120 such that the updated images best represent the visual characteristic(s) as selected by the user. For instance, in some examples, the feedback component(s) 126 may use the visual data 120 to process the reference image used to generate the sample images in order to generate an updated image. The feedback component(s) 126 may then determine one or more differences (e.g., one or more errors) between the updated image and the selected image and generate feedback data 128 associated with the difference(s). For instance, the feedback data 128 may represent the difference(s) and/or one or more parameters that are associated with the difference(s).

Additionally, or alternatively, in some examples, the feedback component(s) 126 may use the visual data 120 to process a new rendered image in order to generate an updated image. The feedback component(s) 126 may then determine one or more differences (e.g., one or more errors) between the updated image and the new rendered image and again generate feedback data 128 associated with the difference(s). For instance, the feedback data 128 may represent the difference(s) and/or one or more parameters that are associated with the difference(s). In any of the examples, the process 100 may include the data generator(s) 118 using the feedback data 128 to update the visual data 120 to generate updated visual data 120. For example, the data generator(s) 118 may use the feedback data 128 to modify and/or update the shader code such that the updated shader code is associated with the parameter(s) that better represents the visual characteristic(s) as updated by the user.

For more details, FIGS. 6A-6B illustrate example of determining feedback that is then used to update data representing parameters for updating visual characteristics, in accordance with some embodiments of the present disclosure. As shown by the example of FIG. 6A, the processing engine(s) 122 may initially process the image data representing the reference image 202 along with the visual data 402 to generate updated image data representing an updated image 602. Since the updated image 602 was generated using the visual data 402, the updated image 602 should include similar visual characteristics as the second sample image 206(2) used to generate the visual data 402. As such, the feedback component(s) 126 may process the updated image data representing the second sample image 206(2) and the updated image data representing the updated image 602 to determine differences between the second sample image 206(2) and the updated image 602, such as pixel value differences, luminance differences, contrast differences, brightness differences, saturation differences, color differences, texture differences, and/or any other visual differences. As described herein, in some examples, the differences may correspond to errors in the updated image 602. The feedback component(s) 126 may then generate feedback data 604 representing the difference(s) and/or one or more parameters associated with the difference(s).

As shown by the example of FIG. 6B, the data generator(s) 118 may then process the visual data 402 and the feedback data 604 and, based at least on the processing, generate updated visual data 606. For instance, the updated visual data 606 may be associated with updating images of the application to better include the updated visual characteristic(s), such as the increased brightness selected by the user. For instance, in some examples, the updated visual data 606 may represent updated shader code that is associated with the parameter(s) determined to update the visual characteristic(s).

In some examples, this process may then continue to repeat where the processing engine(s) 122 uses the image data representing the reference image 202 and the updated visual data 606 to generate image data representing updated images, the feedback component(s) 126 processes the updated image data representing the second sample image 206(2) and the updated image data representing the updated images to generate additional feedback data 604, and the data generator(s) 118 processes the updated visual data 606 and the updated feedback data 604 to generate additional updated visual data 606. This way, the data generator(s) 118 may continue to update the visual data 402 to better represent the visual characteristic(s) as requested by the user. In some examples, this process may continue to repeat until the occurrence of one or more events, such as the differences (the errors) between the images are within a threshold.

Referring back to the example of FIG. 1, in some examples, the process 100 may repeat when additional input data 104 is received that includes an additional request to update one or more visual characteristics associated with the images. For instance, the process 100 may repeat in order to generate updated visual data 120 that is associated with the additional request from the user. Additionally, or alternatively, in some examples, a portion of the process 100 may continue to repeat even when additional input data 104 is not received. For a first example, at least the feedback component(s) 126 may continue to process images in order to generate feedback data 128 for updating the visual data 120. For a second example, the image analyzer(s) 114 may continue to perform one or more of the processes described herein to generate the parameter data 116 and the data generator(s) 118 may continue to process the parameter data 116 to generate the visual data 120.

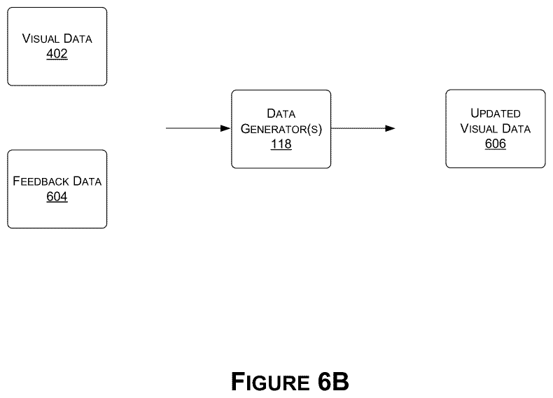

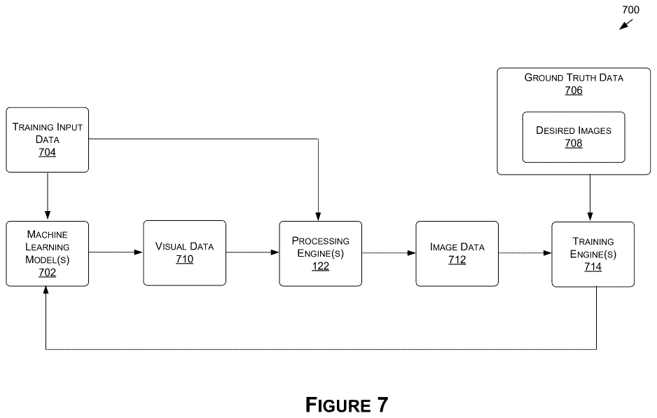

As described herein, in some examples, one or more of the machine learning models may be trained to perform one or more of the processes described herein. For instance, FIG. 7 illustrates an example of a data flow diagram for training one or more machine learning models 702 (the model 702) to generate data for updating visual characteristics of images, in accordance with some embodiments of the present disclosure. In some examples, the data generator(s) 118 may include and/or use the model(s) 702 to perform at least a portion of the processing described herein.

As shown, the model(s) 702 may be trained using training input data 704. In some examples, the training input data 704 may represent visual data—such as shader files and/or shader code—associated with updating visual characteristics of images. In some examples, the training input data 704 may further represent training images and/or parameters associated with updating the visual characteristics. For example, at least a portion of the training input data 704 may be similar to the parameter data 116 that is processed by the model(s) 702 during inference. In some examples, the training input data 704 may be real produced (e.g., generated during one or more sessions associated with an application, such as a gaming application), synthetically produced (e.g., generated using one or more simulations), and/or any combination thereof.

The model(s) 702 may be trained using the training input data 704 along with corresponding ground truth data 706. As shown, in some examples, the ground truth data 706 may represent desired images 708 associated with the input training images, where the desired images 708 include updated visual characteristics. For example, the visual characteristics of the training input images may have been updated in order to generate the desired images 708. In some examples, for each instance of the training input data 704 (e.g., for each training input image), there may be corresponding ground truth data 706 (e.g., a corresponding desired image 708). Additionally, in some examples, the ground truth data 706 may be real produced (e.g., generated using one or more of the processes described herein), synthetically produced (e.g., generated using one or more simulations), human labeled, machine labeled, and/or any combination thereof.

As shown, the process 700 may include the model(s) 702 processing the training input data 704 to generate visual data 710 corresponding to the training input data 704. The process 700 may then include the processing engine(s) 122 processing the training input data 704 representing the training images and the visual data 710 to generate image data 712 representing updated images. To train the model(s) 702, one or more training engines 714 may then use one or more loss functions that measure loss (e.g., error) in the image data 712 as compared to the ground truth data 706. For instance, in some examples, the loss function(s) may measure the loss based at least on differences between the updated images represented by the image data 712 to the desired images 708. The training engine(s) 714 may then perform backward pass computations to recursively compute gradients of the loss function(s) with respect to training parameters in order to update the parameters and/or weights of the model(s) 702.

As such, by performing the process 700 of FIG. 7, the model(s) 702 may be trained to generate the visual data—such as the shader code—that is used to update visual characteristics of images according to requests from users. For instance, if the visual data represents shader code, the model(s) 702 may be trained to generate and/or update shader code that may then be used to update visual characteristics of images according to the requests from the users.

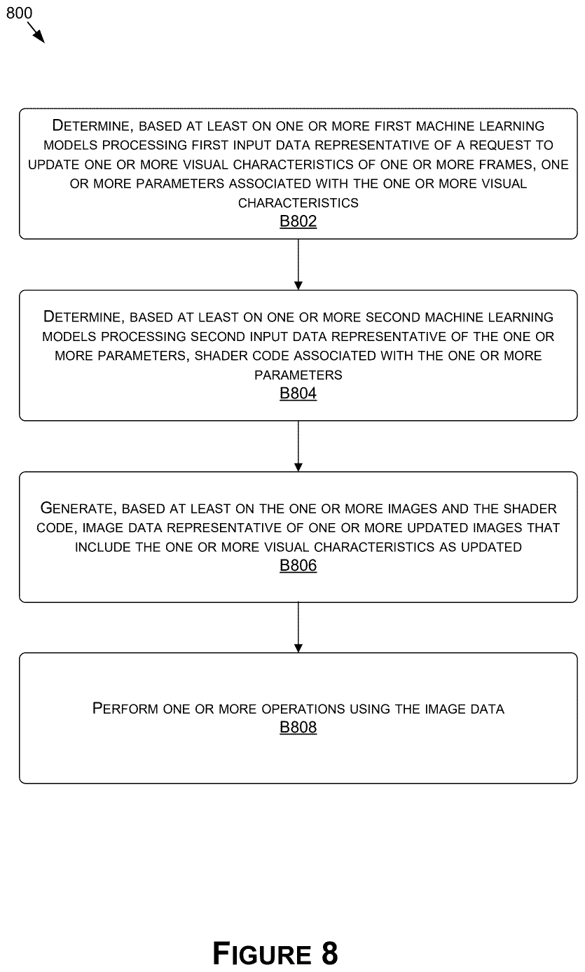

Now referring to FIGS. 8-10 each block of methods 800, 900, and 1000, described herein, comprises a computing process that may be performed using any combination of hardware, firmware, and/or software. For instance, various functions may be carried out by a processor executing instructions stored in memory. The methods 800, 900, and 1000 may also be embodied as computer-usable instructions stored on computer storage media. The methods 800, 900, and 1000 may be provided by a standalone application, a service or hosted service (standalone or in combination with another hosted service), or a plug-in to another product, to name a few. In addition, the methods 800, 900, and 1000 are described, by way of example, with respect to the system of FIG. 1. However, these methods 800, 900, and 1000 may additionally or alternatively be executed by any one system, or any combination of systems, including, but not limited to, those described herein.

FIG. 8 illustrates a flow diagram showing a method 800 for using artificial intelligence to generate shader code for altering content associated with an application, in accordance with some embodiments of the present disclosure. The method 800, at block B802, may include determining, based at least on one or more first machine learning models processing first input data representative of a request to update one or more visual characteristics of one or more images, one or more parameters associated with the one or more visual characteristics. For instance, the image generator(s) 110 may process the input data 104 and/or the image data 102 to determine a selected image 112, using one or more of the processes described herein. For example, the image generator(s) 110 may generate one or more sample images, provide the sample image(s) to a user, and then receive a selection associated with the selected image 112. The image analyzer(s) 114 may then process the image data 102 and image data representing the selected image 112 to generate the parameter data 116 representing the parameter(s) associated with the visual characteristic(s). In some examples, the image analyzer(s) 114 may further generate prompt data representing a prompt associated with generating shader code using the parameter(s).

The method 800, at block B804, may include determining, based at least on one or more second machine learning models processing second input data representative of the one or more parameters, shader code associated with the one or more parameters. For instance, the data generator(s) 118 may process the parameter data 116 (and/or the prompt data representing the prompt) to generate the visual data 120. As described herein, in some examples, the visual data 120 may represent the shader code associated with the parameter(s). Additionally, in some examples, the data generator(s) 118 may be trained to generate the shader code for updating the image(s).

The method 800, at block B806, may include generating, based at least on the one or more images and the shader code, image data representative of one or more updated images that include the one or more visual characteristics as updated. For instance, the processing engine(s) 122 may process the image data 102 and the visual data 120 to generate the updated image data 124 representing the updated image(s) that include the updated visual characteristic(s). As described herein, in some examples, the updated image(s) may include updated pixel values, luminance, contrast, brightness, saturation, color, texture, and/or any other type of visual characteristic.

The method 800, at block B808, may include performing one or more operations using the image data. For instance, if a remote system (e.g., an application server(s) 1102) generates the updated image data 124, then the remote system may send the updated image data 124 to a client device (e.g., a client device 1104) for displaying the updated image(s). Additionally, if the client device generates the updated image data 124, then the client device may use the updated image data 124 to display the updated image(s). Still, in some examples, the operation(s) may include performing any other type of operation, such as the feedback component(s) 126 processing the image data 102 with respect to the updated image data 124 to generate feedback data 128 for updating the visual data 120.

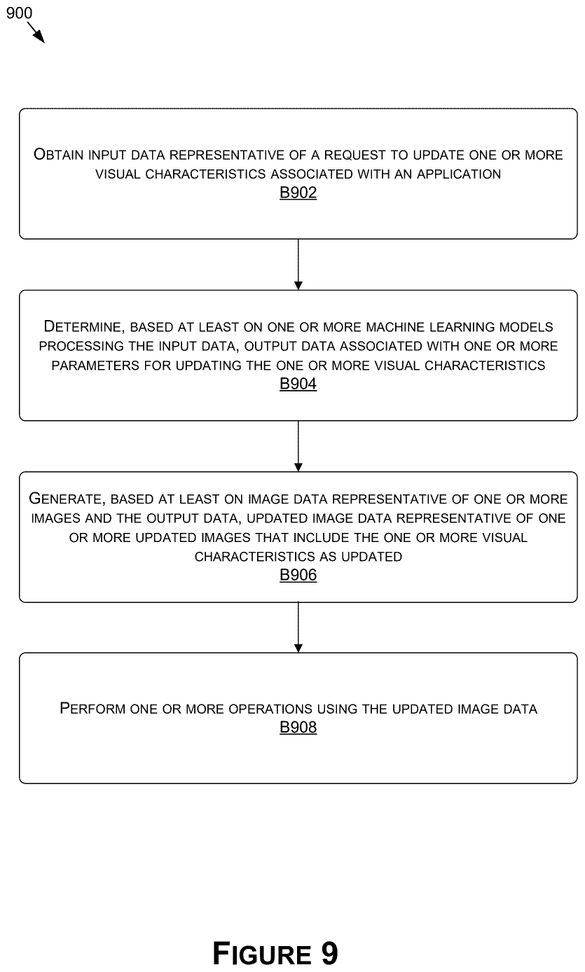

FIG. 9 illustrates a flow diagram showing a method 900 for using artificial intelligence to alter content associated with an application, in accordance with some embodiments of the present disclosure. The method 900, at block B902, may include obtaining input data representative of a request to update one or more visual characteristics associated with an application. For instance, the input data 104 representing the request to update the visual characteristic(s)—such as a luminance, a brightness, a contrast, a saturation, a color, a texture, and/or any other visual characteristic—may be obtained. In some examples, the input data 104 may include audio data representing speech from a user, where the speech indicates the request to update the visual characteristic(s). However, in other examples, the input data 104 may include any other type of data, such as text data representing text, selection data representing one or more options, and/or the like. Additionally, in some examples, the request may indicate a level and/or degree associated with updating the visual characteristic(s). For a first example, if the visual characteristic is associated with a brightness, then the request may indicate to increase the brightness and/or increase the brightness by a given level. For a second example, if the visual characteristic is associated with contrast, then the request may indicate to increase the contrast and/or increase the contrast ratio by a given amount.

The method 900, at block B904, may include determining, based at least on one or more machine learning models processing the input data, output data associated with one or more parameters for updating the one or more visual characteristics. For instance, the image generator(s) 110 may process the input data 104 and/or the image data 102 to determine a selected image 112, using one or more of the processes described herein. The image analyzer(s) 114 may then process the image data 102 and image data representing the selected image 112 to generate the parameter data 116 representing the parameter(s) associated with the visual characteristic(s). Additionally, the data generator(s) 118 may process the parameter data 116 and/or prompt data representing a prompt to generate the visual data 120.

The method 900, at block B906, may include generating, based at least on image data representative of one or more images and the output data, updated image data representative of one or more updated images that include the one or more visual characteristics as updated. For instance, the processing engine(s) 122 may process the image data 102 and the visual data 120 to generate the updated image data 124 representing the updated image(s) that include the updated visual characteristic(s).

The method 900, at block B908, may include performing one or more operations using the updated image data. For instance, if a remote system (e.g., an application server(s) 1102) generates the updated image data 124, then the remote system may send the updated image data 124 to a client device (e.g., a client device 1104) for displaying the updated image(s). Additionally, if the client device generates the updated image data 124, then the client device may use the updated image data 124 to display the updated image(s). Still, in some examples, the operation(s) may include performing any other type of operation, such as the feedback component(s) 126 processing the image data 102 with respect to the updated image data 124 to generate feedback data 128 for updating the visual data 120.

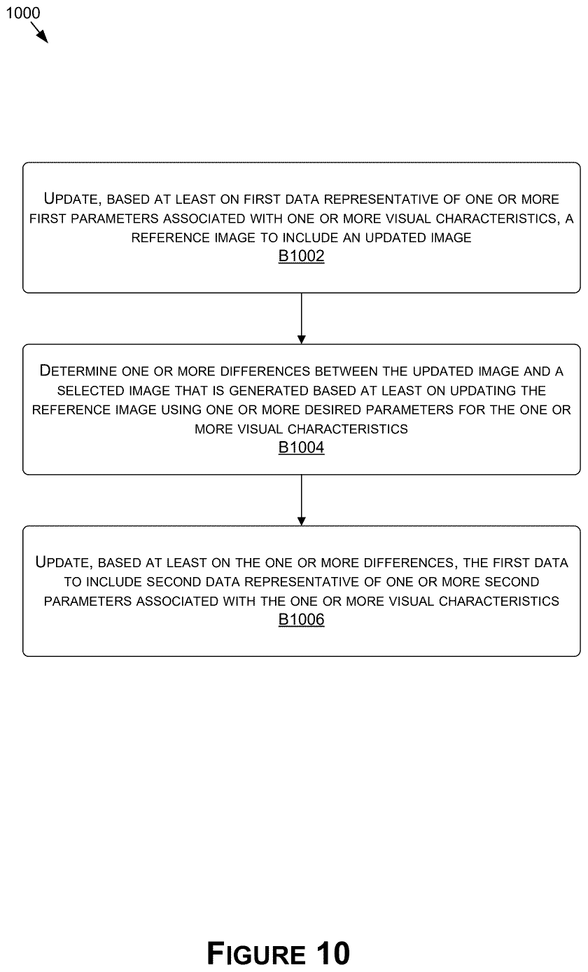

FIG. 10 illustrates a flow diagram showing a method 1000 for using feedback to update visual data associated with parameters for visual characteristics, in accordance with some embodiments of the present disclosure. The method 1000, at block B1002, may include updating, based at least on first data representative of one or more first parameters associated with one or more visual characteristics, a reference image to include an updated image. For instance, the processing engine(s) 122 may use the first visual data 120 to update the reference image to include the updated image. As described herein, in some examples, the first visual data 120 may represent first shader code associated with the first parameter(s). Additionally, the visual characteristic(s) may include a luminance, a brightness, a contrast, a saturation, a color, a texture, and/or any other visual characteristic.

The method 1000, at block B1004, may include determining one or more differences between the updated image and a selected image that is generated based at least on updating the reference image using one or more desired parameters for the one or more visual characteristics. For instance, the feedback component(s) 126 may compare the updated image to the selected image 112 to determine the difference(s) between the updated image and the selected image(s). As described herein, in some examples, the difference(s) may be associated with one or more errors corresponding to the first parameter data 116. Additionally, the difference(s) may be associated with one or more pixel value differences, luminance differences, contrast differences, brightness differences, saturation differences, color differences, texture differences, and/or any other type of difference between the updated image and the selected image 112.

The method 1000, at block B1006, may include updating, based at least on the one or more differences, the first data to include second data representative of one or more second parameters associated with the one or more visual characteristics. For instance, the data generator(s) may use the first visual data 120 and the feedback data 128 to generate second visual data 120 associated with the second parameter(s). As described herein, in some examples, the second visual data 120 may represent second shader code associated with the second parameter(s).

### Example Content Streaming System

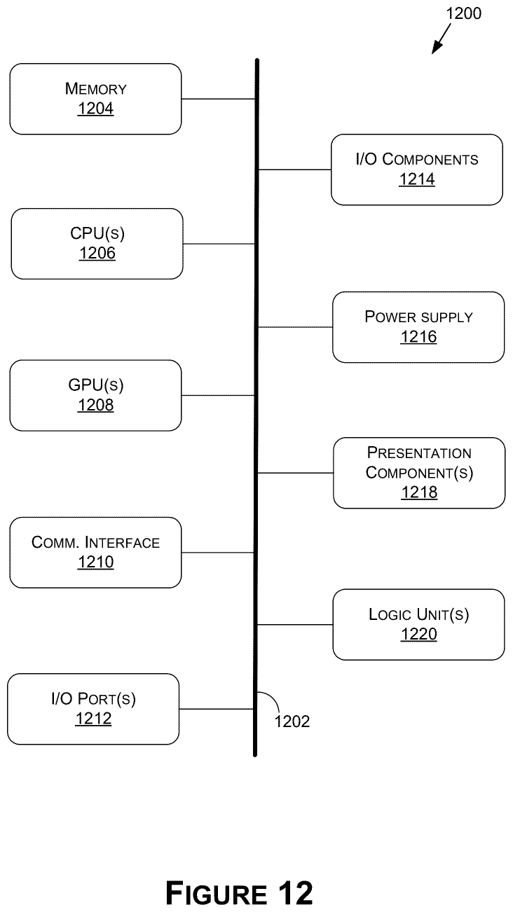

Now referring to FIG. 11, FIG. 11 is an example system diagram for a content streaming system 1100, in accordance with some embodiments of the present disclosure. FIG. 11 includes application server(s) 1102 (which may include similar components, features, and/or functionality to the example computing device 1200 of FIG. 12), client device(s) 1104 (which may include similar components, features, and/or functionality to the example computing device 1200 of FIG. 12), and network(s) 1106 (which may be similar to the network(s) described herein). In some embodiments of the present disclosure, the system 1100 may be implemented. The application session may correspond to a game streaming application (e.g., NVIDIA GeFORCE NOW), a remote desktop application, a simulation application (e.g., autonomous or semi-autonomous vehicle simulation), computer aided design (CAD) applications, virtual reality (VR) and/or augmented reality (AR) streaming applications, deep learning applications, and/or other application types.

In the system 1100, for an application session, the client device(s) 1104 may only receive input data in response to inputs to the input device(s), transmit the input data to the application server(s) 1102, receive encoded display data from the application server(s) 1102, and display the display data on the display 1124. As such, the more computationally intense computing and processing is offloaded to the application server(s) 1102 (e.g., rendering—in particular ray or path tracing—for graphical output of the application session is executed by the GPU(s) of the game server(s) 1102). In other words, the application session is streamed to the client device(s) 1104 from the application server(s) 1102, thereby reducing the requirements of the client device(s) 1104 for graphics processing and rendering.

For example, with respect to an instantiation of an application session, a client device 1104 may be displaying a frame of the application session on the display 1124 based on receiving the display data from the application server(s) 1102. The client device 1104 may receive an input to one of the input device(s) and generate input data in response. The client device 1104 may transmit the input data to the application server(s) 1102 via the communication interface 1120 and over the network(s) 1106 (e.g., the Internet), and the application server(s) 1102 may receive the input data via the communication interface 1118. The CPU(s) may receive the input data, process the input data, and transmit data to the GPU(s) that causes the GPU(s) to generate a rendering of the application session. For example, the input data may be representative of a movement of a character of the user in a game session of a game application, firing a weapon, reloading, passing a ball, turning a vehicle, etc. The rendering component 1112 may render the application session (e.g., representative of the result of the input data) and the render capture component 1114 may capture the rendering of the application session as display data (e.g., as image data capturing the rendered frame of the application session). The rendering of the application session may include ray or path-traced lighting and/or shadow effects, computed using one or more parallel processing units—such as GPUs, which may further employ the use of one or more dedicated hardware accelerators or processing cores to perform ray or path-tracing techniques—of the application server(s) 1102. In some embodiments, one or more virtual machines (VMs)—e.g., including one or more virtual components, such as vGPUs, vCPUs, etc. may be used by the application server(s) 1102 to support the application sessions. The encoder 1116 may then encode the display data to generate encoded display data and the encoded display data may be transmitted to the client device 1104 over the network(s) 1106 via the communication interface 1118. The client device 1104 may receive the encoded display data via the communication interface 1120 and the decoder 1122 may decode the encoded display data to generate the display data. The client device 1104 may then display the display data via the display 1124.

The systems and methods described herein may be used for a variety of purposes, by way of example and without limitation, for machine control, machine locomotion, machine driving, synthetic data generation, model training, perception, augmented reality, virtual reality, mixed reality, robotics, security and surveillance, simulation and digital twinning, autonomous or semi-autonomous machine applications, deep learning, environment simulation, data center processing, conversational AI, light transport simulation (e.g., ray-tracing, path tracing, etc.), collaborative content creation for 3D assets, cloud computing and/or any other suitable applications.

Disclosed embodiments may be comprised in a variety of different systems such as automotive systems (e.g., a control system for an autonomous or semi-autonomous machine, a perception system for an autonomous or semi-autonomous machine), systems implemented using a robot, aerial systems, medial systems, boating systems, smart area monitoring systems, systems for performing deep learning operations, systems for performing simulation operations, systems for performing digital twin operations, systems implemented using an edge device, systems incorporating one or more virtual machines (VMs), systems for performing synthetic data generation operations, systems implemented at least partially in a data center, systems for performing conversational AI operations, systems for performing light transport simulation, systems for performing collaborative content creation for 3D assets, systems implemented at least partially using cloud computing resources, and/or other types of systems.

As further shown by the example of FIG. 11, the application server(s) 1102 may store and/or execute the NLP engine(s) 106, the image generator(s) 110, the image analyzer(s) 114, the data generator(s) 118, and/or the feedback component(s) 126 to perform one or more of the processes described herein. For example, the application server(s) 1102 may receive the input data 104 from a client device 1104, perform at least a portion of the processing described herein to generate the updated image data 124, and then send the updated image data 124 to the client device 1104 for display the updated images using the display 1124. Additionally, or alternatively, in some examples, the client device 1104 may store and/or execute the NLP engine(s) 106, the image generator(s) 110, the image analyzer(s) 114, the data generator(s) 118, and/or the feedback component(s) 126 to perform one or more of the processes described herein. For example, the client device 1104 may receive the image data 102 from the application server(s) 1102 and/or generate the image data 102, perform at least a portion of the processing described herein to generate the updated image data 124, and then display the updated images using the display 1124.

As further illustrated in the example of FIG. 11, the application server(s) 1102 (and/or the client device(s) 1104) may store application data 1128 representing one or more applications. As described herein, an application may include, but is not limited to, a gaming application, an interactive application (which may include one or more of these other types of applications), a visual application (which may include one or more of these other types of applications), a multimedia application (e.g., a video streaming application, a music streaming application, a voice streaming application, a multimedia streaming application that includes both audio and video, etc.), a communications application (e.g., a video conferencing application, etc.), an educational application, a collaborative content creation application, an entertainment application (e.g., a show, a movie, etc.), or any other type of application.

### Example Language Models

In at least some embodiments, language models, such as large language models (LLMs), vision language models (VLMs), multi-modal language models (MMLMs), and/or other types of generative artificial intelligence (AI) may be implemented. These models may be capable of understanding, summarizing, translating, and/or otherwise generating text (e.g., natural language text, code, etc.), images, video, computer aided design (CAD) assets, OMNIVERSE and/or METAVERSE file information (e.g., in USD format, such as OpenUSD), and/or the like, based on the context provided in input prompts or queries. These language models may be considered “large,” in embodiments, based on the models being trained on massive datasets and having architectures with large number of learnable network parameters (weights and biases) such as millions or billions of parameters. The LLMs/VLMs/MMLMs/etc. may be implemented for summarizing textual data, analyzing and extracting insights from data (e.g., textual, image, video, etc.), and generating new text/image/video/etc. in user-specified styles, tones, and/or formats. The LLMs/VLMs/MMLMs/etc. of the present disclosure may be used exclusively for text processing, in embodiments, whereas in other embodiments, multi-modal LLMs may be implemented to accept, understand, and/or generate text and/or other types of content like images, audio, 2D and/or 3D data (e.g., in USD formats), and/or video. For example, vision language models (VLMs), or more generally multi-modal language models (MMLMs), may be implemented to accept image, video, audio, textual, 3D design (e.g., CAD), and/or other inputs data types and/or to generate or output image, video, audio, textual, 3D design, and/or other output data types.

Various types of LLMs/VLMs/MMLMs/etc. architectures may be implemented in various embodiments. For example, different architectures may be implemented that use different techniques for understanding and generating outputs—such as text, audio, video, image, 2D and/or 3D design or asset data, etc. In some embodiments, LLMs/VLMs/MMLMs/etc. architectures such as recurrent neural networks (RNNs) or long short-term memory networks (LSTMs) may be used, while in other embodiments transformer architectures—such as those that rely on self-attention and/or cross-attention (e.g., between contextual data and textual data) mechanisms—may be used to understand and recognize relationships between words or tokens and/or contextual data (e.g., other text, video, image, design data, USD, etc.). One or more generative processing pipelines that include LLMs/VLMs/MMLMs/etc. may also include one or more diffusion block(s) (e.g., denoisers). The LLMs/VLMs/MMLMs/etc. of the present disclosure may include encoder and/or decoder block(s). For example, discriminative or encoder-only models like BERT (Bidirectional Encoder Representations from Transformers) may be implemented for tasks that involve language comprehension such as classification, sentiment analysis, question answering, and named entity recognition. As another example, generative or decoder-only models like GPT (Generative Pretrained Transformer) may be implemented for tasks that involve language and content generation such as text completion, story generation, and dialogue generation. LLMs/VLMs/MMLMs/etc. that include both encoder and decoder components like T5 (Text-to-Text Transformer) may be implemented to understand and generate content, such as for translation and summarization. These examples are not intended to be limiting, and any architecture type including but not limited to those described herein—may be implemented depending on the particular embodiment and the task(s) being performed using the LLMs/VLMs/MMLMs/etc.

In various embodiments, the LLMs/VLMs/MMLMs/etc. may be trained using unsupervised learning, in which an LLMs/VLMs/MMLMs/etc. learns patterns from large amounts of unlabeled text/audio/video/image/design/USD/etc. data. Due to the extensive training, in embodiments, the models may not require task-specific or domain-specific training. LLMs/VLMs/MMLMs/etc. that have undergone extensive pre-training on vast amounts of unlabeled data may be referred to as foundation models and may be adept at a variety of tasks like question-answering, summarization, filling in missing information, translation, image/video/design/USD/data generation. Some LLMs/VLMs/MMLMs/etc. may be tailored for a specific use case using techniques like prompt tuning, fine-tuning, retrieval augmented generation (RAG), adding adapters (e.g., customized neural networks, and/or neural network layers, that tune or adjust prompts or tokens to bias the language model toward a particular task or domain), and/or using other fine-tuning or tailoring techniques that optimize the models for use on particular tasks and/or within particular domains.

In some embodiments, the LLMs/VLMs/MMLMs/etc. of the present disclosure may be implemented using various model alignment techniques. For example, in some embodiments, guardrails may be implemented to identify improper or undesired inputs (e.g., prompts) and/or outputs of the models. In doing so, the system may use the guardrails and/or other model alignment techniques to either prevent a particular undesired input from being processed using the LLMs/VLMs/MMLMs/etc., and/or preventing the output or presentation (e.g., display, audio output, etc.) of information generating using the LLMs/VLMs/MMLMs/etc. In some embodiments, one or more additional models—or layers thereof—may be implemented to identify issues with inputs and/or outputs of the models. For example, these “safeguard” models may be trained to identify inputs and/or outputs that are “safe” or otherwise okay or desired and/or that are “unsafe” or are otherwise undesired for the particular application/implementation. As a result, the LLMs/VLMs/MMLMs/etc. of the present disclosure may be less likely to output language/text/audio/video/design data/USD data/etc. that may be offensive, vulgar, improper, unsafe, out of domain, and/or otherwise undesired for the particular application/implementation.

In some embodiments, the LLMs/VLMs/etc. may be configured to or capable of accessing or using one or more plug-ins, application programming interfaces (APIs), databases, data stores, repositories, etc. For example, for certain tasks or operations that the model is not ideally suited for, the model may have instructions (e.g., as a result of training, and/or based on instructions in a given prompt) to access one or more plug-ins (e.g., 3^{rd} party plugins) for help in processing the current input. In such an example, where at least part of a prompt is related to restaurants or weather, the model may access one or more restaurant or weather plug-ins (e.g., via one or more APIs) to retrieve the relevant information. As another example, where at least part of a response requires a mathematical computation, the model may access one or more math plug-ins or APIs for help in solving the problem(s), and may then use the response from the plug-in and/or API in the output from the model. This process may be repeated—e.g., recursively—for any number of iterations and using any number of plug-ins and/or APIs until a response to the input prompt can be generated that addresses each ask/question/request/process/operation/etc. As such, the model(s) may not only rely on its own knowledge from training on a large dataset(s), but also on the expertise or optimized nature of one or more external resources—such as APIs, plug-ins, and/or the like.

In some embodiments, multiple language models (e.g., LLMs/VLMs/MMLMs/etc., multiple instances of the same language model, and/or multiple prompts provided to the same language model or instance of the same language model may be implemented, executed, or accessed (e.g., using one or more plug-ins, user interfaces, APIs, databases, data stores, repositories, etc.) to provide output responsive to the same query, or responsive to separate portions of a query. In at least one embodiment, multiple language models e.g., language models with different architectures, language models trained on different (e.g. updated) corpuses of data may be provided with the same input query and prompt (e.g., set of constraints, conditioners, etc.). In one or more embodiments, the language models may be different versions of the same foundation model. In one or more embodiments, at least one language model may be instantiated as multiple agents—e.g., more than one prompt may be provided to constrain, direct, or otherwise influence a style, a content, or a character, etc., of the output provided. In one or more example, non-limiting embodiments, the same language model may be asked to provide output corresponding to a different role, perspective, character, or having a different base of knowledge, etc.—as defined by a supplied prompt.

In any one of such embodiments, the output of two or more (e.g., each) language models, two or more versions of at least one language model, two or more instanced agents of at least one language model, and/or two more prompts provided to at least one language model may be further processed, e.g., aggregated, compared or filtered against, or used to determine (and provide) a consensus response. In one or more embodiments, the output from one language model—or version, instance, or agent—maybe be provided as input to another language model for further processing and/or validation. In one or more embodiments, a language model may be asked to generate or otherwise obtain an output with respect to an input source material, with the output being associated with the input source material. Such an association may include, for example, the generation of a caption or portion of text that is embedded (e.g., as metadata) with an input source text or image. In one or more embodiments, an output of a language model may be used to determine the validity of an input source material for further processing, or inclusion in a dataset. For example, a language model may be used to assess the presence (or absence) of a target word in a portion of text or an object in an image, with the text or image being annotated to note such presence (or lack thereof). Alternatively, the determination from the language model may be used to determine whether the source material should be included in a curated dataset, for example and without limitation.

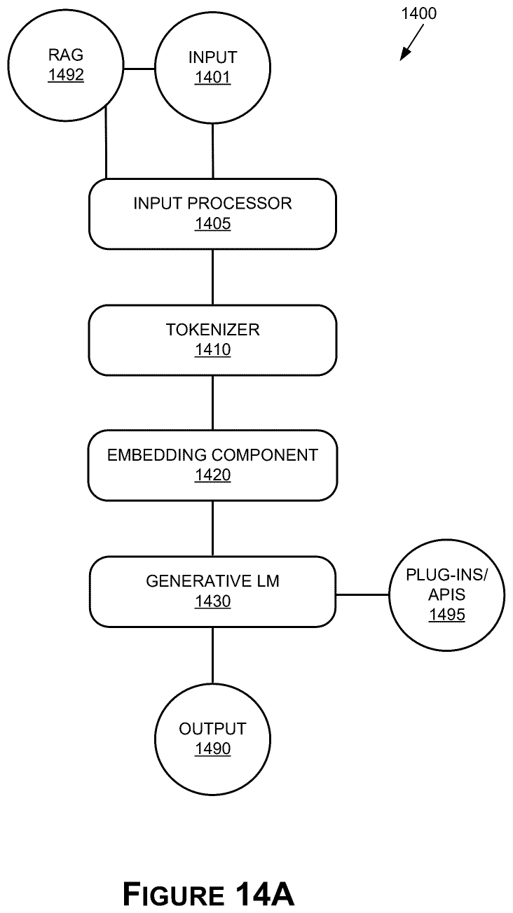

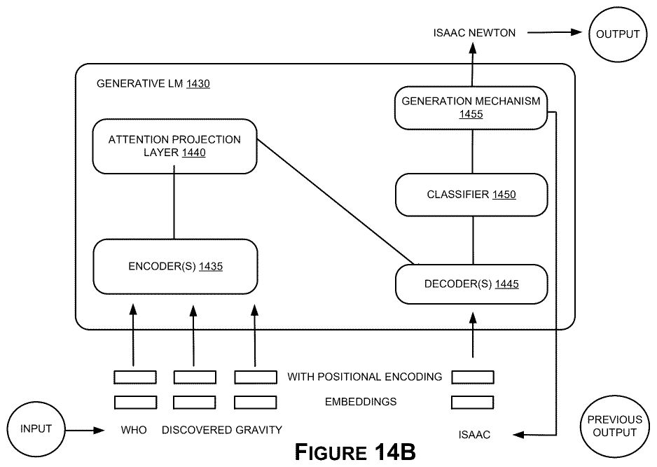

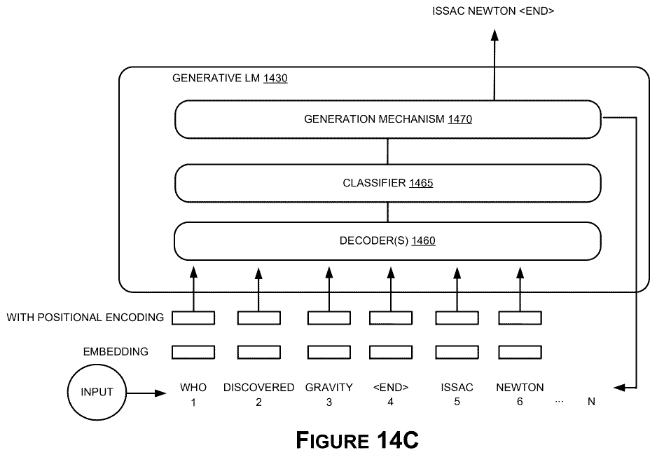

FIG. 14A is a block diagram of an example generative language model system 1400 suitable for use in implementing at least some embodiments of the present disclosure. In the example illustrated in FIG. 14A, the generative language model system 1400 includes a retrieval augmented generation (RAG) component 1492, an input processor 1405, a tokenizer 1410, an embedding component 1420, plug-ins/APIs 1495, and a generative language model (LM) 1430 (which may include an LLM, a VLM, a multi-modal LM, etc.).

At a high level, the input processor 1405 may receive an input 1401 comprising text and/or other types of input data (e.g., audio data, video data, image data, sensor data (e.g., LiDAR, RADAR, ultrasonic, etc.), 3D design data, CAD data, universal scene descriptor (USD) data—such as OpenUSD, etc.), depending on the architecture of the generative LM 1430 (e.g., LLM/VLM/MMLM/etc.). In some embodiments, the input 1401 includes plain text in the form of one or more sentences, paragraphs, and/or documents. Additionally or alternatively, the input 1401 may include numerical sequences, precomputed embeddings (e.g., word or sentence embeddings), and/or structured data (e.g., in tabular formats, JSON, or XML). In some implementations in which the generative LM 1430 is capable of processing multi-modal inputs, the input 1401 may combine text (or may omit text) with image data, audio data, video data, design data, USD data, and/or other types of input data, such as but not limited to those described herein. Taking raw input text as an example, the input processor 1405 may prepare raw input text in various ways. For example, the input processor 1405 may perform various types of text filtering to remove noise (e.g., special characters, punctuation, HTML tags, stopwords, portions of an image(s), portions of audio, etc.) from relevant textual content. In an example involving stopwords (common words that tend to carry little semantic meaning), the input processor 1405 may remove stopwords to reduce noise and focus the generative LM 1430 on more meaningful content. The input processor 1405 may apply text normalization, for example, by converting all characters to lowercase, removing accents, and/or or handling special cases like contractions or abbreviations to ensure consistency. These are just a few examples, and other types of input processing may be applied.

In some embodiments, a RAG component 1492 (which may include one or more RAG models, and/or may be performed using the generative LM 1430 itself) may be used to retrieve additional information to be used as part of the input 1401 or prompt. RAG may be used to enhance the input to the LLM/VLM/MMLM/etc. with external knowledge, so that answers to specific questions or queries or requests are more relevant—such as in a case where specific knowledge is required. The RAG component 1492 may fetch this additional information (e.g., grounding information, such as grounding text/image/video/audio/USD/CAD/etc.) from one or more external sources, which can then be fed to the LLM/VLM/MMLM/etc. along with the prompt to improve accuracy of the responses or outputs of the model.

For example, in some embodiments, the input 1401 may be generated using the query or input to the model (e.g., a question, a request, etc.) in addition to data retrieved using the RAG component 1492. In some embodiments, the input processor 1405 may analyze the input 1401 and communicate with the RAG component 1492 (or the RAG component 1492 may be part of the input processor 1405, in embodiments) in order to identify relevant text and/or other data to provide to the generative LM 1430 as additional context or sources of information from which to identify the response, answer, or output 1490, generally. For example, where the input indicates that the user is interested in a desired tire pressure for a particular make and model of vehicle, the RAG component 1492 may retrieve—using a RAG model performing a vector search in an embedding space, for example—the tire pressure information or the text corresponding thereto from a digital (embedded) version of the user manual for that particular vehicle make and model. Similarly, where a user revisits a chatbot related to a particular product offering or service, the RAG component 1492 may retrieve a prior stored conversation history—or at least a summary thereof—and include the prior conversation history along with the current ask/request as part of the input 1401 to the generative LM 1430.

The RAG component 1492 may use various RAG techniques. For example, naïve RAG may be used where documents are indexed, chunked, and applied to an embedding model to generate embeddings corresponding to the chunks. A user query may also be applied to the embedding model and/or another embedding model of the RAG component 1492 and the embeddings of the chunks along with the embeddings of the query may be compared to identify the most similar/related embeddings to the query, which may be supplied to the generative LM 1430 to generate an output.

In some embodiments, more advanced RAG techniques may be used. For example, prior to passing chunks to the embedding model, the chunks may undergo pre-retrieval processes (e.g., routing, rewriting, metadata analysis, expansion, etc.). In addition, prior to generating the final embeddings, post-retrieval processes (e.g., re-ranking, prompt compression, etc.) may be performed on the outputs of the embedding model prior to final embeddings being used as comparison to an input query.

As a further example, modular RAG techniques may be used, such as those that are similar to naïve and/or advanced RAG, but also include features such as hybrid search, recursive retrieval and query engines, StepBack approaches, sub-queries, and hypothetical document embedding.

As another example, Graph RAG may use knowledge graphs as a source of context or factual information. Graph RAG may be implemented using a graph database as a source of contextual information sent to the LLM/VLM/MMLM/etc. Rather than (or in addition to) providing the model with chunks of data extracted from larger sized documents—which may result in a lack of context, factual correctness, language accuracy, etc.—graph RAG may also provide structured entity information to the LLM/VLM/MMLM/etc. by combining the structured entity textual description with its many properties and relationships, allowing for deeper insights by the model. When implementing graph RAG, the systems and methods described herein use a graph as a content store and extract relevant chunks of documents and ask the LLM/VLM/MMLM/etc. to answer using them. The knowledge graph, in such embodiments, may contain relevant textual content and metadata about the knowledge graph as well as be integrated with a vector database. In some embodiments, the graph RAG may use a graph as a subject matter expert, where descriptions of concepts and entities relevant to a query/prompt may be extracted and passed to the model as semantic context. These descriptions may include relationships between the concepts. In other examples, the graph may be used as a database, where part of a query/prompt may be mapped to a graph query, the graph query may be executed, and the LLM/VLM/MMLM/etc. may summarize the results. In such an example, the graph may store relevant factual information, and a query (natural language query) to graph query tool (NL-to-Graph-query tool) and entity linking may be used. In some embodiments, graph RAG (e.g., using a graph database) may be combined with standard (e.g., vector database) RAG, and/or other RAG types, to benefit from multiple approaches.

In any embodiments, the RAG component 1492 may implement a plugin, API, user interface, and/or other functionality to perform RAG. For example, a graph RAG plug-in may be used by the LLM/VLM/MMLM/etc. to run queries against the knowledge graph to extract relevant information for feeding to the model, and a standard or vector RAG plug-in may be used to run queries against a vector database. For example, the graph database may interact with a plug-in's REST interface such that the graph database is decoupled from the vector database and/or the embeddings models.

The tokenizer 1410 may segment the (e.g., processed) text data into smaller units (tokens) for subsequent analysis and processing. The tokens may represent individual words, subwords, characters, portions of audio/video/image/etc., depending on the implementation. Word-based tokenization divides the text into individual words, treating each word as a separate token. Subword tokenization breaks down words into smaller meaningful units (e.g., prefixes, suffixes, stems), enabling the generative LM 1430 to understand morphological variations and handle out-of-vocabulary words more effectively. Character-based tokenization represents each character as a separate token, enabling the generative LM 1430 to process text at a fine-grained level. The choice of tokenization strategy may depend on factors such as the language being processed, the task at hand, and/or characteristics of the training dataset. As such, the tokenizer 1410 may convert the (e.g., processed) text into a structured format according to tokenization schema being implemented in the particular embodiment.

The embedding component 1420 may use any known embedding technique to transform discrete tokens into (e.g., dense, continuous vector) representations of semantic meaning. For example, the embedding component 1420 may use pre-trained word embeddings (e.g., Word2Vec, GloVe, or FastText), one-hot encoding, Term Frequency-Inverse Document Frequency (TF-IDF) encoding, one or more embedding layers of a neural network, and/or otherwise.

In some implementations in which the input 1401 includes image data/video data/etc., the input processor 1401 may resize the data to a standard size compatible with format of a corresponding input channel and/or may normalize pixel values to a common range (e.g., 0 to 1) to ensure a consistent representation, and the embedding component 1420 may encode the image data using any known technique (e.g., using one or more convolutional neural networks (CNNs) to extract visual features). In some implementations in which the input 1401 includes audio data, the input processor 1401 may resample an audio file to a consistent sampling rate for uniform processing, and the embedding component 1420 may use any known technique to extract and encode audio features—such as in the form of a spectrogram (e.g., a mel-spectrogram). In some implementations in which the input 1401 includes video data, the input processor 1401 may extract frames or apply resizing to extracted frames, and the embedding component 1420 may extract features such as optical flow embeddings or video embeddings and/or may encode temporal information or sequences of frames. In some implementations in which the input 1401 includes multi-modal data, the embedding component 1420 may fuse representations of the different types of data (e.g., text, image, audio, USD, video, design, etc.) using techniques like early fusion (concatenation), late fusion (sequential processing), attention-based fusion (e.g., self-attention, cross-attention), etc.

The generative LM 1430 and/or other components of the generative LM system 1400 may use different types of neural network architectures depending on the implementation. For example, transformer-based architectures such as those used in models like GPT may be implemented, and may include self-attention mechanisms that weigh the importance of different words or tokens in the input sequence and/or feedforward networks that process the output of the self-attention layers, applying non-linear transformations to the input representations and extracting higher-level features. Some non-limiting example architectures include transformers (e.g., encoder-decoder, decoder only, multi-modal), RNNs, LSTMs, fusion models, diffusion models, cross-modal embedding models that learn joint embedding spaces, graph neural networks (GNNs), hybrid architectures combining different types of architectures adversarial networks like generative adversarial networks or GANs or adversarial autoencoders (AAEs) for joint distribution learning, and others. As such, depending on the implementation and architecture, the embedding component 1420 may apply an encoded representation of the input 1401 to the generative LM 1430, and the generative LM 1430 may process the encoded representation of the input 1401 to generate an output 1490, which may include responsive text and/or other types of data.

As described herein, in some embodiments, the generative LM 1430 may be configured to access or use—or capable of accessing or using—plug-ins/APIs 1495 (which may include one or more plug-ins, application programming interfaces (APIs), databases, data stores, repositories, etc.). For example, for certain tasks or operations that the generative LM 1430 is not ideally suited for, the model may have instructions (e.g., as a result of training, and/or based on instructions in a given prompt, such as those retrieved using the RAG component 1492) to access one or more plug-ins/APIs 1495 (e.g., 3^{rd} party plugins) for help in processing the current input. In such an example, where at least part of a prompt is related to restaurants or weather, the model may access one or more restaurant or weather plug-ins (e.g., via one or more APIs), send at least a portion of the prompt related to the particular plug-in/API 1495 to the plug-in/API 1495, the plug-in/API 1495 may process the information and return an answer to the generative LM 1430, and the generative LM 1430 may use the response to generate the output 1490. This process may be repeated—e.g., recursively—for any number of iterations and using any number of plug-ins/APIs 1495 until an output 1490 that addresses each ask/question/request/process/operation/etc. from the input 1401 can be generated. As such, the model(s) may not only rely on its own knowledge from training on a large dataset(s) and/or from data retrieved using the RAG component 1492, but also on the expertise or optimized nature of one or more external resources—such as the plug-ins/APIs 1495.

FIG. 14B is a block diagram of an example implementation in which the generative LM 1430 includes a transformer encoder-decoder. For example, assume input text such as “Who discovered gravity” is tokenized (e.g., by the tokenizer 1410 of FIG. 14A) into tokens such as words, and each token is encoded (e.g., by the embedding component 1420 of FIG. 914A) into a corresponding embedding (e.g., of size 512). Since these token embeddings typically do not represent the position of the token in the input sequence, any known technique may be used to add a positional encoding to each token embedding to encode the sequential relationships and context of the tokens in the input sequence. As such, the (e.g., resulting) embeddings may be applied to one or more encoder(s) 1435 of the generative LM 1430.

In an example implementation, the encoder(s) 1435 forms an encoder stack, where each encoder includes a self-attention layer and a feedforward network. In an example transformer architecture, each token (e.g., word) flows through a separate path. As such, each encoder may accept a sequence of vectors, passing each vector through the self-attention layer, then the feedforward network, and then upwards to the next encoder in the stack. Any known self-attention technique may be used. For example, to calculate a self-attention score for each token (word), a query vector, a key vector, and a value vector may be created for each token, a self-attention score may be calculated for pairs of tokens by taking the dot product of the query vector with the corresponding key vectors, normalizing the resulting scores, multiplying by corresponding value vectors, and summing weighted value vectors. The encoder may apply multi-headed attention in which the attention mechanism is applied multiple times in parallel with different learned weight matrices. Any number of encoders may be cascaded to generate a context vector encoding the input. An attention projection layer 1440 may convert the context vector into attention vectors (keys and values) for the decoder(s) 1445.

In an example implementation, the decoder(s) 1445 form a decoder stack, where each decoder includes a self-attention layer, an encoder-decoder self-attention layer that uses the attention vectors (keys and values) from the encoder to focus on relevant parts of the input sequence, and a feedforward network. As with the encoder(s) 1435, in an example transformer architecture, each token (e.g., word) flows through a separate path in the decoder(s) 1445. During a first pass, the decoder(s) 1445, a classifier 1450, and a generation mechanism 1455 may generate a first token, and the generation mechanism 1455 may apply the generated token as an input during a second pass. The process may repeat in a loop, successively generating and adding tokens (e.g., words) to the output from the preceding pass and applying the token embeddings of the composite sequence with positional encodings as an input to the decoder(s) 1445 during a subsequent pass, sequentially generating one token at a time (known as auto-regression) until predicting a symbol or token that represents the end of the response. Within each decoder, the self-attention layer is typically constrained to attend only to preceding positions in the output sequence by applying a masking technique (e.g., setting future positions to negative infinity) before the softmax operation. In an example implementation, the encoder-decoder attention layer operates similarly to the (e.g., multi-headed) self-attention in the encoder(s) 1435, except that it creates its queries from the layer below it and takes the keys and values (e.g., matrix) from the output of the encoder(s) 1435.

As such, the decoder(s) 1445 may output some decoded (e.g., vector) representation of the input being applied during a particular pass. The classifier 1450 may include a multi-class classifier comprising one or more neural network layers that project the decoded (e.g., vector) representation into a corresponding dimensionality (e.g., one dimension for each supported word or token in the output vocabulary) and a softmax operation that converts logits to probabilities. As such, the generation mechanism 1455 may select or sample a word or token based on a corresponding predicted probability (e.g., select the word with the highest predicted probability) and append it to the output from a previous pass, generating each word or token sequentially. The generation mechanism 1455 may repeat the process, triggering successive decoder inputs and corresponding predictions until selecting or sampling a symbol or token that represents the end of the response, at which point, the generation mechanism 1455 may output the generated response.

FIG. 14C is a block diagram of an example implementation in which the generative LM 1430 includes a decoder-only transformer architecture. For example, the decoder(s) 1460 of FIG. 14C may operate similarly as the decoder(s) 1445 of FIG. 14B except each of the decoder(s) 1460 of FIG. 14C omits the encoder-decoder self-attention layer (since there is no encoder in this implementation). As such, the decoder(s) 1460 may form a decoder stack, where each decoder includes a self-attention layer and a feedforward network. Furthermore, instead of encoding the input sequence, a symbol or token representing the end of the input sequence (or the beginning of the output sequence) may be appended to the input sequence, and the resulting sequence (e.g., corresponding embeddings with positional encodings) may be applied to the decoder(s) 1460. As with the decoder(s) 1445 of FIG. 14B, each token (e.g., word) may flow through a separate path in the decoder(s) 1460, and the decoder(s) 1460, a classifier 1465, and a generation mechanism 1470 may use auto-regression to sequentially generate one token at a time until predicting a symbol or token that represents the end of the response. The classifier 1465 and the generation mechanism 1470 may operate similarly as the classifier 1450 and the generation mechanism 1455 of FIG. 14B, with the generation mechanism 1470 selecting or sampling each successive output token based on a corresponding predicted probability and appending it to the output from a previous pass, generating each token sequentially until selecting or sampling a symbol or token that represents the end of the response. These and other architectures described herein are meant simply as examples, and other suitable architectures may be implemented within the scope of the present disclosure.

### Example Computing Device

FIG. 12 is a block diagram of an example computing device(s) 1200 suitable for use in implementing some embodiments of the present disclosure. Computing device 1200 may include an interconnect system 1202 that directly or indirectly couples the following devices: memory 1204, one or more central processing units (CPUs) 1206, one or more graphics processing units (GPUs) 1208, a communication interface 1210, input/output (I/O) ports 1212, input/output components 1214, a power supply 1216, one or more presentation components 1218 (e.g., display(s)), and one or more logic units 1220. In at least one embodiment, the computing device(s) 1200 may comprise one or more virtual machines (VMs), and/or any of the components thereof may comprise virtual components (e.g., virtual hardware components). For non-limiting examples, one or more of the GPUs 1208 may comprise one or more vGPUs, one or more of the CPUs 1206 may comprise one or more vCPUs, and/or one or more of the logic units 1220 may comprise one or more virtual logic units. As such, a computing device(s) 1200 may include discrete components (e.g., a full GPU dedicated to the computing device 1200), virtual components (e.g., a portion of a GPU dedicated to the computing device 1200), or a combination thereof.

Although the various blocks of FIG. 12 are shown as connected via the interconnect system 1202 with lines, this is not intended to be limiting and is for clarity only. For example, in some embodiments, a presentation component 1218, such as a display device, may be considered an I/O component 1214 (e.g., if the display is a touch screen). As another example, the CPUs 1206 and/or GPUs 1208 may include memory (e.g., the memory 1204 may be representative of a storage device in addition to the memory of the GPUs 1208, the CPUs 1206, and/or other components). As such, the computing device of FIG. 12 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 12.

The interconnect system 1202 may represent one or more links or busses, such as an address bus, a data bus, a control bus, or a combination thereof. The interconnect system 1202 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 1206 may be directly connected to the memory 1204. Further, the CPU 1206 may be directly connected to the GPU 1208. Where there is direct, or point-to-point connection between components, the interconnect system 1202 may include a PCIe link to carry out the connection. In these examples, a PCI bus need not be included in the computing device 1200.

The memory 1204 may include any of a variety of computer-readable media. The computer-readable media may be any available media that may be accessed by the computing device 1200. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 1204 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 1200. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 1206 may be configured to execute at least some of the computer-readable instructions to control one or more components of the computing device 1200 to perform one or more of the methods and/or processes described herein. The CPU(s) 1206 may each include one or more cores (e.g., one, two, four, eight, twenty-eight, seventy-two, etc.) that are capable of handling a multitude of software threads simultaneously. The CPU(s) 1206 may include any type of processor, and may include different types of processors depending on the type of computing device 1200 implemented (e.g., processors with fewer cores for mobile devices and processors with more cores for servers). For example, depending on the type of computing device 1200, the processor may be an Advanced RISC Machines (ARM) processor implemented using Reduced Instruction Set Computing (RISC) or an x86 processor implemented using Complex Instruction Set Computing (CISC). The computing device 1200 may include one or more CPUs 1206 in addition to one or more microprocessors or supplementary co-processors, such as math co-processors.

In addition to or alternatively from the CPU(s) 1206, the GPU(s) 1208 may be configured to execute at least some of the computer-readable instructions to control one or more components of the computing device 1200 to perform one or more of the methods and/or processes described herein. One or more of the GPU(s) 1208 may be an integrated GPU (e.g., with one or more of the CPU(s) 1206 and/or one or more of the GPU(s) 1208 may be a discrete GPU. In embodiments, one or more of the GPU(s) 1208 may be a coprocessor of one or more of the CPU(s) 1206. The GPU(s) 1208 may be used by the computing device 1200 to render graphics (e.g., 3D graphics) or perform general purpose computations. For example, the GPU(s) 1208 may be used for General-Purpose computing on GPUs (GPGPU). The GPU(s) 1208 may include hundreds or thousands of cores that are capable of handling hundreds or thousands of software threads simultaneously. The GPU(s) 1208 may generate pixel data for output images in response to rendering commands (e.g., rendering commands from the CPU(s) 1206 received via a host interface). The GPU(s) 1208 may include graphics memory, such as display memory, for storing pixel data or any other suitable data, such as GPGPU data. The display memory may be included as part of the memory 1204. The GPU(s) 1208 may include two or more GPUs operating in parallel (e.g., via a link). The link may directly connect the GPUs (e.g., using NVLINK) or may connect the GPUs through a switch (e.g., using NVSwitch). When combined together, each GPU 1208 may generate pixel data or GPGPU data for different portions of an output or for different outputs (e.g., a first GPU for a first image and a second GPU for a second image). Each GPU may include its own memory, or may share memory with other GPUs.

In addition to or alternatively from the CPU(s) 1206 and/or the GPU(s) 1208, the logic unit(s) 1220 may be configured to execute at least some of the computer-readable instructions to control one or more components of the computing device 1200 to perform one or more of the methods and/or processes described herein. In embodiments, the CPU(s) 1206, the GPU(s) 1208, and/or the logic unit(s) 1220 may discretely or jointly perform any combination of the methods, processes and/or portions thereof. One or more of the logic units 1220 may be part of and/or integrated in one or more of the CPU(s) 1206 and/or the GPU(s) 1208 and/or one or more of the logic units 1220 may be discrete components or otherwise external to the CPU(s) 1206 and/or the GPU(s) 1208. In embodiments, one or more of the logic units 1220 may be a coprocessor of one or more of the CPU(s) 1206 and/or one or more of the GPU(s) 1208.

Examples of the logic unit(s) 1220 include one or more processing cores and/or components thereof, such as Data Processing Units (DPUs), Tensor Cores (TCs), Tensor Processing Units (TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Programmable Vision Accelerator (PVAs)—which may include one or more direct memory access (DMA) systems, one or more vision or vector processing units (VPUs), one or more pixel processing engines (PPEs)—e.g., including a 2D array of processing elements that each communicate north, south, east, and west with one or more other processing elements in the array, one or more decoupled accelerators or units (e.g., decoupled lookup table (DLUT) accelerators or units), etc., Vision Processing Units (VPUs), Optical Flow Accelerators (OFAs), Field Programmable Gate Arrays (FPGAs), Neuromorphic Chips, Quantum Processing Units (QPUs), Associative Process Units (APUs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 1210 may include one or more receivers, transmitters, and/or transceivers that allow the computing device 1200 to communicate with other computing devices via an electronic communication network, included wired and/or wireless communications. The communication interface 1210 may include components and functionality to allow communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, logic unit(s) 1220 and/or communication interface 1210 may include one or more data processing units (DPUs) to transmit data received over a network and/or through interconnect system 1202 directly to (e.g., a memory of) one or more GPU(s) 1208.

The I/O ports 1212 may allow the computing device 1200 to be logically coupled to other devices including the I/O components 1214, the presentation component(s) 1218, and/or other components, some of which may be built in to (e.g., integrated in) the computing device 1200. Illustrative I/O components 1214 include a microphone, mouse, keyboard, joystick, game pad, game controller, satellite dish, scanner, printer, wireless device, etc. The I/O components 1214 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 1200. The computing device 1200 may be include depth cameras, such as stereoscopic camera systems, infrared camera systems, RGB camera systems, touchscreen technology, and combinations of these, for gesture detection and recognition. Additionally, the computing device 1200 may include accelerometers or gyroscopes (e.g., as part of an inertia measurement unit (IMU)) that allow detection of motion. In some examples, the output of the accelerometers or gyroscopes may be used by the computing device 1200 to render immersive augmented reality or virtual reality.

The power supply 1216 may include a hard-wired power supply, a battery power supply, or a combination thereof. The power supply 1216 may provide power to the computing device 1200 to allow the components of the computing device 1200 to operate.

The presentation component(s) 1218 may include a display (e.g., a monitor, a touch screen, a television screen, a heads-up-display (HUD), other display types, or a combination thereof), speakers, and/or other presentation components. The presentation component(s) 1218 may receive data from other components (e.g., the GPU(s) 1208, the CPU(s) 1206, DPUs, etc.), and output the data (e.g., as an image, video, sound, etc.).

### Example Data Center

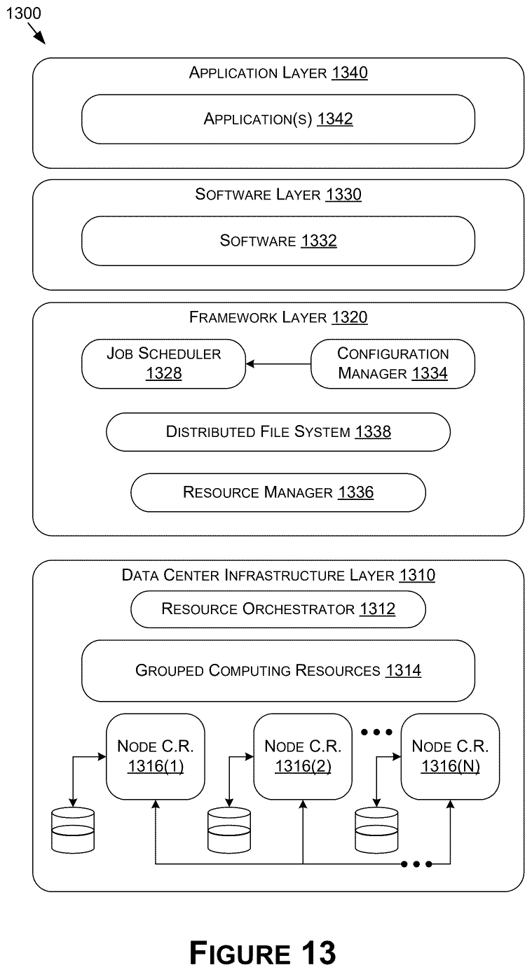

FIG. 13 illustrates an example data center 1300 that may be used in at least one embodiments of the present disclosure. The data center 1300 may include a data center infrastructure layer 1310, a framework layer 1320, a software layer 1330, and/or an application layer 1340.

As shown in FIG. 13, the data center infrastructure layer 1310 may include a resource orchestrator 1312, grouped computing resources 1314, and node computing resources (“node C.R.s”) 1316(1)-1316(N), where “N” represents any whole, positive integer. In at least one embodiment, node C.R.s 1316(1)-1316(N) may include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some embodiments, one or more node C.R.s from among node C.R.s 1316(1)-1316(N) may correspond to a server having one or more of the above-mentioned computing resources. In addition, in some embodiments, the node C.R.s 1316(1)-13161(N) may include one or more virtual components, such as vGPUs, vCPUs, and/or the like, and/or one or more of the node C.R.s 1316(1)-1316(N) may correspond to a virtual machine (VM).

In at least one embodiment, grouped computing resources 1314 may include separate groupings of node C.R.s 1316 housed within one or more racks (not shown), or many racks housed in data centers at various geographical locations (also not shown). Separate groupings of node C.R.s 1316 within grouped computing resources 1314 may include grouped compute, network, memory or storage resources that may be configured or allocated to support one or more workloads. In at least one embodiment, several node C.R.s 1316 including CPUs, GPUs, DPUs, and/or other processors may be grouped within one or more racks to provide compute resources to support one or more workloads. The one or more racks may also include any number of power modules, cooling modules, and/or network switches, in any combination.

The resource orchestrator 1312 may configure or otherwise control one or more node C.R.s 1316(1)-1316(N) and/or grouped computing resources 1314. In at least one embodiment, resource orchestrator 1312 may include a software design infrastructure (SDI) management entity for the data center 1300. The resource orchestrator 1312 may include hardware, software, or some combination thereof.

In at least one embodiment, as shown in FIG. 13, framework layer 1320 may include a job scheduler 1328, a configuration manager 1334, a resource manager 1336, and/or a distributed file system 1338. The framework layer 1320 may include a framework to support software 1332 of software layer 1330 and/or one or more application(s) 1342 of application layer 1340. The software 1332 or application(s) 1342 may respectively include web-based service software or applications, such as those provided by Amazon Web Services, Google Cloud and Microsoft Azure. The framework layer 1320 may be, but is not limited to, a type of free and open-source software web application framework such as Apache Spark™ (hereinafter “Spark”) that may use distributed file system 1338 for large-scale data processing (e.g., “big data”). In at least one embodiment, job scheduler 1328 may include a Spark driver to facilitate scheduling of workloads supported by various layers of data center 1300. The configuration manager 1334 may be capable of configuring different layers such as software layer 1330 and framework layer 1320 including Spark and distributed file system 1338 for supporting large-scale data processing. The resource manager 1336 may be capable of managing clustered or grouped computing resources mapped to or allocated for support of distributed file system 1338 and job scheduler 1328. In at least one embodiment, clustered or grouped computing resources may include grouped computing resource 1314 at data center infrastructure layer 1310. The resource manager 1336 may coordinate with resource orchestrator 1312 to manage these mapped or allocated computing resources.

In at least one embodiment, software 1332 included in software layer 1330 may include software used by at least portions of node C.R.s 1316(1)-1316(N), grouped computing resources 1314, and/or distributed file system 1338 of framework layer 1320. One or more types of software may include, but are not limited to, Internet web page search software, e-mail virus scan software, database software, and streaming video content software.

In at least one embodiment, application(s) 1342 included in application layer 1340 may include one or more types of applications used by at least portions of node C.R.s 1316(1)-1316(N), grouped computing resources 1314, and/or distributed file system 1338 of framework layer 1320. One or more types of applications may include, but are not limited to, any number of a genomics application, a cognitive compute, and a machine learning application, including training or inferencing software, machine learning framework software (e.g., PyTorch, TensorFlow, Caffe, etc.), and/or other machine learning applications used in conjunction with one or more embodiments.

In at least one embodiment, any of configuration manager 1334, resource manager 1336, and resource orchestrator 1312 may implement any number and type of self-modifying actions based on any amount and type of data acquired in any technically feasible fashion. Self-modifying actions may relieve a data center operator of data center 1300 from making possibly bad configuration decisions and possibly avoiding underutilized and/or poor performing portions of a data center.

The data center 1300 may include tools, services, software or other resources to train one or more machine learning models or predict or infer information using one or more machine learning models according to one or more embodiments described herein. For example, a machine learning model(s) may be trained by calculating weight parameters according to a neural network architecture using software and/or computing resources described above with respect to the data center 1300. In at least one embodiment, trained or deployed machine learning models corresponding to one or more neural networks may be used to infer or predict information using resources described above with respect to the data center 1300 by using weight parameters calculated through one or more training techniques, such as but not limited to those described herein.

In at least one embodiment, the data center 1300 may use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described above may be configured as a service to allow users to train or performing inferencing of information, such as image recognition, speech recognition, or other artificial intelligence services.

### Example Network Environments

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the computing device(s) 1200 of FIG. 12—e.g., each device may include similar components, features, and/or functionality of the computing device(s) 1200. In addition, where backend devices (e.g., servers, NAS, etc.) are implemented, the backend devices may be included as part of a data center 1300, an example of which is described in more detail herein with respect to FIG. 13.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment—and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example computing device(s) 1200 described herein with respect to FIG. 12. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

### Example Paragraphs

A: A method comprising: determining, based at least on one or more first machine learning models processing first input data representative of a request to update one or more visual characteristics associated with one or more images, one or more parameters associated with updating the one or more visual characteristics; determining, based at least on one or more second machine learning models processing second input data representative of the one or more parameters, shader code associated with updating the one or more visual characteristics; generating, based at least on the one or more images and the shader code, image data representative of one or more updated images that include the one or more visual characteristics as updated; and performing one or more operations using the image data.
B: The method of paragraph A, wherein the determining the one or more parameters comprises: generating, based at least on the one or more first machine learning models processing the first input data, one or more sample images associated with the one or more visual characteristics as updated; receiving an indication associated with a sample image of the one or more sample images; and determining the one or more parameters based at least on the sample image.
C: The method of paragraph B, further comprising: causing a presentation of the one or more sample images associated with the one or more visual characteristics as updated, wherein the receiving the indication comprises receiving input data representing a selection of the sample image.
D: The method of any one of paragraphs A-C, wherein the determining the one or more parameters comprises: determining, based at least on the one or more first machine learning models processing the first input data and second image data representative of a reference image, a sample image associated with the one or more visual characteristics as updated; determining one or more differences between the sample image and the reference image; and determining the one or more parameters based at least on the one or more differences.
E: The method of paragraph D, wherein the determining the one or more differences comprises at least one of: determining one or more first differences between one or more first pixel values associated with the sample image and one or more second pixel values associated with the reference image; or determining one or more second differences between one or more first attributes associated with the sample image and one or more second attributes associated with the reference image.
F: The method of any one of paragraphs A-E, wherein: the one or more visual characteristics include at least one of: a luminance associated with the one or more images; a contrast associated with the one or more images; a brightness associated with the one or more images; a saturation associated with the one or more images; a color associated with the one or more images; or a texture associated with the one or more images; and the one or more parameters include at least one of: one or more pixel values; luminance information; contrast information; brightness information; saturation information; color information; or texture information.
G: The method of any one of paragraphs A-F, further comprising: determining one or more differences between the one or more images and the one or more updated images; and determining, using the one or more second machine learning models and based at least on third input data representative of the shader code and the one or more differences, second shader code associated with one or more second parameters associated with updating the one or more visual characteristics.
H: The method of any one of paragraphs A-G, wherein the performing the one or more operations using the image data comprises at least one of: displaying the one or more updated images using the image data; or sending the image data to one or more client devices for displaying the one or more updated images.
I: The method of any one of paragraphs A-H, wherein the one or more second machine learning models are trained, at least, by: determining, using the one or more second machine learning models and based at least on third input data associated with one or more training images, second shader data; generating, based at least on the one or more training images and the second shader code, one or more second updated images; comparing the one or more second updated images to one or more desired images; and training the one or more second machine learning models based at least on the comparing.
J: A system comprising: one or more processors to: determine, based at least on a request to update one or more visual characteristics, one or more parameters associated with updating the one or more visual characteristics; determine, based at least on one or more machine learning models processing input data representative of the one or more parameters, output data associated with updating the one or more visual characteristics; generate, based at least one or more images and the output data, image data representative of one or more updated images that include the one or more visual characteristics as updated; and perform one or more operations using the image data.
K: The system of paragraph J, wherein the determination of the one or more parameters comprises: generating, based at least on the request and one or more reference images, one or more sample images associated with the one or more visual characteristics as updated; receiving an indication associated with a sample image of the one or more sample images; and determining the one or more parameters based at least on the sample image.
L: The system of paragraph K, wherein the one or more processors are further to: cause a presentation of the one or more sample images associated with the one or more visual characteristics as updated, wherein the indication includes a selection of the sample image from the one or more sample images.
M: The system of paragraph K, wherein: the request indicates a level associated with updating the one or more visual characteristics; and the generating the one or more samples images is based at least on the level associated with updating the one or more visual characteristics.
N: The system of any one of paragraphs J-M, wherein the determination of the one or more parameters comprises: determining, based at least on the request and a reference image, a sample image associated with the one or more visual characteristics as updated; determining one or more differences between the sample image and the reference image; and determining the one or more parameters based at least on the one or more differences.
O: The system of any one of paragraphs J-N, wherein: the output data represents shader code associated with the one or more parameters; and the generation of the image data is performed by one or more graphics processing units using the shader code.
P: The system of any one of paragraphs J-O, wherein the one or more processors are further to: receive audio data representing speech; and generating, based at least on one or more second machine learning models processing the audio data, text representing the request to update the one or more visual characteristics, wherein the one or more parameters are determined based at least on the text.
Q: The system of any one of paragraphs J-P, wherein the one or more processors are further to: generate, based at least on the request and one or more reference images, one or more sample images associated with the one or more visual characteristics as updated; generate, based at least on the one or more reference images and the output data, second image data representative of one or more second updated images that include the one or more visual characteristics as updated; determine one or more differences between the one or more sample images and the one or more second updated images; and determine, using the one or more machine learning models and based at least on the output data and second input data representative of the one or more differences, second output data associated with updating the one or more visual characteristics.
R: The system of any one of paragraphs J-Q, wherein the system is comprised in at least one of: a control system for an autonomous or semi-autonomous machine; a perception system for an autonomous or semi-autonomous machine; a system for performing one or more simulation operations; a system for performing one or more digital twin operations; a system for performing light transport simulation; a system for performing collaborative content creation for 3D assets; a system that provides one or more cloud gaming applications; a system for performing one or more deep learning operations; a system implemented using an edge device; a system implemented using a robot; a system for performing one or more generative AI operations; a system for performing operations using one or more large language models (LLMs); a system for performing operations using one or more vision language models (VLMs); a system for performing operations using one or more multi-modal language models; a system for performing one or more conversational AI operations; a system for generating synthetic data; a system for presenting at least one of virtual reality content, augmented reality content, or mixed reality content; systems implementing one or more multi-modal language models; systems using or deploying one or more inference microservices; systems that incorporate deploy one or more machine learning models in a service or microservice along with an OS-level virtualization package (e.g., a container); a system incorporating one or more virtual machines (VMs); a system implemented at least partially in a data center; or a system implemented at least partially using cloud computing resources.
S: One or more processors comprising: processing circuitry to generate image data representing one or more images that include one or more visual characteristics updated based at least on shader code representing one or more parameters associated with the one or more visual characteristics, wherein the shader code is determined based at least on one or more machine learning models processing input data representing a request to update the one or more visual characteristics.
T: The one or more processors of paragraph S, wherein the one or more processors are comprised in at least one of: a control system for an autonomous or semi-autonomous machine; a perception system for an autonomous or semi-autonomous machine; a system for performing one or more simulation operations; a system for performing one or more digital twin operations; a system for performing light transport simulation; a system for performing collaborative content creation for 3D assets; a system that provides one or more cloud gaming applications; a system for performing one or more deep learning operations; a system implemented using an edge device; a system implemented using a robot; a system for performing one or more generative AI operations; a system for performing operations using one or more large language models (LLMs); a system for performing operations using one or more vision language models (VLMs); a system for performing operations using one or more multi-modal language models; a system for performing one or more conversational AI operations; a system for generating synthetic data; a system for presenting at least one of virtual reality content, augmented reality content, or mixed reality content; systems implementing one or more multi-modal language models; systems using or deploying one or more inference microservices; systems that incorporate deploy one or more machine learning models in a service or microservice along with an OS-level virtualization package (e.g., a container); a system incorporating one or more virtual machines (VMs); a system implemented at least partially in a data center; or a system implemented at least partially using cloud computing resources.

What is claimed is:

1. A method comprising:
determining, based at least on one or more first machine learning models processing first input data representative of a request to update one or more visual characteristics associated with one or more images, one or more parameters associated with updating the one or more visual characteristics;
determining, based at least on one or more second machine learning models processing second input data representative of the one or more parameters, shader code associated with updating the one or more visual characteristics;
generating, based at least on the one or more images and the shader code, image data representative of one or more updated images that include the one or more visual characteristics as updated; and
performing one or more operations using the image data.

2. The method of claim 1, wherein the determining the one or more parameters comprises:
generating, based at least on the one or more first machine learning models processing the first input data, one or more sample images associated with the one or more visual characteristics as updated;
receiving an indication associated with a sample image of the one or more sample images; and
determining the one or more parameters based at least on the sample image.

3. The method of claim 2, further comprising:
causing a presentation of the one or more sample images associated with the one or more visual characteristics as updated,
wherein the receiving the indication comprises receiving input data representing a selection of the sample image.

4. The method of claim 1, wherein the determining the one or more parameters comprises:
determining, based at least on the one or more first machine learning models processing the first input data and second image data representative of a reference image, a sample image associated with the one or more visual characteristics as updated;
determining one or more differences between the sample image and the reference image; and
determining the one or more parameters based at least on the one or more differences.

5. The method of claim 4, wherein the determining the one or more differences comprises at least one of:
determining one or more first differences between one or more first pixel values associated with the sample image and one or more second pixel values associated with the reference image; or
determining one or more second differences between one or more first attributes associated with the sample image and one or more second attributes associated with the reference image.

6. The method of claim 1, wherein:
the one or more visual characteristics include at least one of:
a luminance associated with the one or more images;
a contrast associated with the one or more images;
a brightness associated with the one or more images;
a saturation associated with the one or more images;
a color associated with the one or more images; or
a texture associated with the one or more images; and
the one or more parameters include at least one of:
one or more pixel values;
luminance information;
contrast information;
brightness information;
saturation information;
color information; or
texture information.

7. The method of claim 1, further comprising:
determining one or more differences between the one or more images and the one or more updated images; and
determining, using the one or more second machine learning models and based at least on third input data representative of the shader code and the one or more differences, second shader code associated with one or more second parameters associated with updating the one or more visual characteristics.

8. The method of claim 1, wherein the performing the one or more operations using the image data comprises at least one of:
displaying the one or more updated images using the image data; or
sending the image data to one or more client devices for displaying the one or more updated images.

9. The method of claim 1, wherein the one or more second machine learning models are trained, at least, by:
determining, using the one or more second machine learning models and based at least on third input data associated with one or more training images, second shader data;
generating, based at least on the one or more training images and the second shader code, one or more second updated images;
comparing the one or more second updated images to one or more desired images; and
training the one or more second machine learning models based at least on the comparing.

10. A system comprising:
one or more processors to:
determine, based at least on a request to update one or more visual characteristics, one or more parameters associated with updating the one or more visual characteristics;
determine, based at least on one or more machine learning models processing input data representative of the one or more parameters, output data associated with updating the one or more visual characteristics;
generate, based at least one or more images and the output data, image data representative of one or more updated images that include the one or more visual characteristics as updated; and
perform one or more operations using the image data.

11. The system of claim 10, wherein the determination of the one or more parameters comprises:
generating, based at least on the request and one or more reference images, one or more sample images associated with the one or more visual characteristics as updated;
receiving an indication associated with a sample image of the one or more sample images; and
determining the one or more parameters based at least on the sample image.

12. The system of claim 11, wherein the one or more processors are further to:
cause a presentation of the one or more sample images associated with the one or more visual characteristics as updated,
wherein the indication includes a selection of the sample image from the one or more sample images.

13. The system of claim 11, wherein:
the request indicates a level associated with updating the one or more visual characteristics; and
the generating the one or more samples images is based at least on the level associated with updating the one or more visual characteristics.

14. The system of claim 10, wherein the determination of the one or more parameters comprises:
determining, based at least on the request and a reference image, a sample image associated with the one or more visual characteristics as updated;
determining one or more differences between the sample image and the reference image; and
determining the one or more parameters based at least on the one or more differences.

15. The system of claim 10, wherein:
the output data represents shader code associated with the one or more parameters; and
the generation of the image data is performed by one or more graphics processing units using the shader code.

16. The system of claim 10, wherein the one or more processors are further to:
receive audio data representing speech; and
generating, based at least on one or more second machine learning models processing the audio data, text representing the request to update the one or more visual characteristics,
wherein the one or more parameters are determined based at least on the text.

17. The system of claim 10, wherein the one or more processors are further to:
generate, based at least on the request and one or more reference images, one or more sample images associated with the one or more visual characteristics as updated;
generate, based at least on the one or more reference images and the output data, second image data representative of one or more second updated images that include the one or more visual characteristics as updated;
determine one or more differences between the one or more sample images and the one or more second updated images; and
determine, using the one or more machine learning models and based at least on the output data and second input data representative of the one or more differences, second output data associated with updating the one or more visual characteristics.

18. The system of claim 10, wherein the system is comprised in at least one of:
a control system for an autonomous or semi-autonomous machine;
a perception system for an autonomous or semi-autonomous machine;
a system for performing one or more simulation operations;
a system for performing one or more digital twin operations;
a system for performing light transport simulation;
a system for performing collaborative content creation for 3D assets;
a system that provides one or more cloud gaming applications;
a system for performing one or more deep learning operations;
a system implemented using an edge device;
a system implemented using a robot;
a system for performing one or more generative AI operations;
a system for performing operations using one or more large language models (LLMs);
a system for performing operations using one or more vision language models (VLMs);
a system for performing operations using one or more multi-modal language models;
a system for performing one or more conversational AI operations;
a system for generating synthetic data;
a system for presenting at least one of virtual reality content, augmented reality content, or mixed reality content;
systems implementing one or more multi-modal language models;
systems using or deploying one or more inference microservices;
systems that incorporate deploy one or more machine learning models in a service or microservice along with an OS-level virtualization package (e.g., a container);
a system incorporating one or more virtual machines (VMs);
a system implemented at least partially in a data center; or
a system implemented at least partially using cloud computing resources.

19. One or more processors comprising:
processing circuitry to generate image data representing one or more images that include one or more visual characteristics updated based at least on shader code representing one or more parameters associated with the one or more visual characteristics, wherein the shader code is determined based at least on one or more machine learning models processing input data representing a request to update the one or more visual characteristics.

20. The one or more processors of claim 19, wherein the one or more processors are comprised in at least one of:
a control system for an autonomous or semi-autonomous machine;
a perception system for an autonomous or semi-autonomous machine;
a system for performing one or more simulation operations;
a system for performing one or more digital twin operations;
a system for performing light transport simulation;
a system for performing collaborative content creation for 3D assets;
a system that provides one or more cloud gaming applications;
a system for performing one or more deep learning operations;
a system implemented using an edge device;
a system implemented using a robot;
a system for performing one or more generative AI operations;
a system for performing operations using one or more large language models (LLMs);
a system for performing operations using one or more vision language models (VLMs);
a system for performing operations using one or more multi-modal language models;
a system for performing one or more conversational AI operations;
a system for generating synthetic data;
a system for presenting at least one of virtual reality content, augmented reality content, or mixed reality content;
systems implementing one or more multi-modal language models;
systems using or deploying one or more inference microservices;
systems that incorporate deploy one or more machine learning models in a service or microservice along with an OS-level virtualization package (e.g., a container);
a system incorporating one or more virtual machines (VMs);
a system implemented at least partially in a data center; or
a system implemented at least partially using cloud computing resources.
